(19) United States
(12) Patent Application Publication
(10) Pub. No.: US 2010/0057600 A1
(43) Pub. Date: Mar. 4, 2010

(54) FINANCIAL TRADING SYSTEM

(75) Inventors: Benny Johansen, Herlev (DK); David John Hague, Copenhagen K (DK)

Correspondence Address: JACOBSON HOLMAN PLLC, 400 SEVENTH STREET N.W., SUITE 600, WASHINGTON, DC, 20004, US

(73) Assignee: SAXO BANK A/S, Gentofte (DK)

(21) Appl. No.: 12/085,322

(22) PCT Filed: Jun. 9, 2006
(86) PCT No.: PCT/DK2006/000323

§ 371 Date: Nov. 16, 2009

Related U.S. Application Data
(60) Provisional application No. 60/738,073, filed on Nov. 21, 2005.

(30) Foreign Application Priority Data
Nov. 21, 2005 (DK) PA 2005 01630

(51) Int. Cl. G06Q 40/00

(52) U.S. Cl. 705/37

(57) ABSTRACT

Disclosed is a computer-implemented system for facilitating generation of a computer-executable financial trading strategy, the system being adapted to provide a graphical user interface for defining a financial trading strategy by arranging interconnectable building blocks into a diagram on a drawing pane provided by the graphical user interface, each building block representing a functional system component of the financial trading strategy; wherein the system includes a plurality of types of functional system components, wherein the drawing pane includes a corresponding plurality of sub-panes, and wherein the system is configured to provide functionality for a user-controlled placement of building blocks into the sub-panes corresponding to the respective types of building blocks.

### FIELD OF THE INVENTION

The present invention relates to the generation/definition of a computer-implemented financial trading system.

### BACKGROUND OF THE INVENTION

It is generally believed within the financial community that it is possible to predict future price movement in a financial instrument by analysing current and past financial information. Many types of financial information are potential inputs to the prediction process, including:
1. Historical and current values of any quantifiable property of the instrument or related instruments, such as price, volume, etc.
2. So called “studies” which are the output of mathematical functions applied to the information listed in 1. An example of a study could be a simple moving average based on the close price of the instrument under consideration.

By analyzing such data it is believed possible to derive at some rules, which when followed will lead to a profitable investment strategy. Such a set of rules is called a financial trading system. An example of a trading system for a financial instrument I includes a rule for when to enter a position in instrument I, and a rule for when to exit a position in instrument I.

A specific example of a simple trading system includes the following rules:
When the 50 day simple moving average (of the close price of instrument I) crosses above the 200 day simple moving average (of the close price of instrument I) then buy 1000 contracts (or shares) of instrument I.
When the 50 day simple moving average (of the close price of instrument I) crosses below the 200 day simple moving average (of the close price of instrument I) then sell 1000 contracts (or shares) of instrument I.

It will be appreciated that a trading system may include one or a plurality of rules, and that the above examples are merely intended to illustrate the term trading system. A trading system may include alternative and/or additional rules.

Such rules can be implemented on a computer or other data processing system. The computer may evaluate relevant information from the categories listed above (historical and current instrument properties, and studies), e.g. a predetermined set of instrument properties and studies. The evaluation may be performed in real-time based on real time input of the instrument properties, or at predetermined times, e.g. periodically at predetermined intervals, or in response to predetermined trigger events, such as user inputs or inputs from other software applications. The computer may then take a predetermined action when the conditions in the specified trading system become true. A computer-executable financial trading system will also be referred to as computer-executable financial trading strategy.

Applications to develop and execute trading systems already exist. These applications first allow a user to define a trading system. They then subsequently monitor relevant financial information in real time and take a specified action. Possible actions include anything from simply alerting the user to actually executing a trade.

An additional feature of most trading system applications is the ability to back test a trading system against historical data. When back testing, the trading system is applied to historical data and the system registers which actions the system would have taken, had it run then. Assuming the actions include buy and sell orders on a given instrument, a user can get statistics on how the system would have performed, had the user started using it during the historical period used as input to the back test.

Examples of currently available trading systems applications include:
The TradeStation system available at http://www.tradestation.com.
The ESignal system available at http://www//esignal.com
The Metastock system available at http://equis.com
The FiberTec system available at http://www.fibertec.com
The StrategyRunner system available at http://www.strategyrunner.com
The TradeNavigator system available at http://www.genesisft.com

Each of the above systems provides to some extent at least some of the following functionality:
Allow the user to define a trading system
Allow the user to specify a historical period and have the application perform a back test of the system on the historical data, resulting in hypothetical historical performance metrics.
Allow the user to submit a trading system for “live execution”, i.e. specify that this trading system should “now” start to perform the specified action in real time, possibly including performing trades.

Benefits from such applications include the fact that the trading system application may constantly monitor the market and can take action immediately, as opposed to a human, who a) cannot monitor all possible investment targets concurrently, b) cannot monitor the market continuously for a prolonged period of time.

Furthermore, a trading system application always follows the specified rules and thus is not influenced by market psychology.

Furthermore, using back testing, the user can get a good idea of how the trading system will perform in the future, before committing real money.

One problem with existing trading system applications is that it is difficult for users without a software background to define the trading system, which they want the application to execute. However, the typical users of such a system are more likely to have a financial background rather than a background in computer programming.

In order to illustrate this difficulty, one may consider the following set of rules for when to exit a trade, as it may be expressed by a user, with financial background:
IF the 50 day simple moving average (of the close price of instrument I) is less than the 200 day simple moving average (of the close price of instrument I)
AND the 50 day simple moving average (of the close price of Instrument I) is falling
AND the 200 simple moving average (of the close price of Instrument I) is falling
AND the 9 day relative strength index is less than 75
THEN SELL

In order to specify this rule-set to the trading system application, the user uses a language. Conventionally, two types of definition languages exist.

The approach used by most applications is that of a scripting language. In an application such as TradeStation the user would have to open up a text editor and write a script. An example of such a script may look as follows:

```
{
  Simple Trading System
}
if Average(Close,50) < Average(Close,200) and
    Average(Close,50)[−1]>Average(Close,50) and
    Average(Close,200)[−1]>Average(Close,200) and
    RSI(Close,9)<75 then begin
    Sell (“Demo Sell”) 1000 shares next bar at market;
end
```

While the meaning of such a script may be relatively clear for a trained user who is familiar with the syntax of the scripting language, it is quite difficult to write for a user without a software development background. Like in any other programming language the spelling, ordering of words and the punctuation has to be correct, in order to be accepted by the application software. Furthermore, in a real-life scenario, the trading systems used are typically considerably more complicated than the above example, and in such a case, the script-based definition of a ‘real’ trading systems may easily become very complex.

There have been attempts to replace the programming language definition with a graphical representation inspired by the flow diagram modelling technique, sometimes used in software development. The user still has to enter the trading system as text, like in the above example; however, once the text has been entered correctly, the system can provide a graphical representation of what was entered.

Using this approach, the above trading system would be represented by a diagram as shown in FIG. 1

The internet publication “An overview of TREE”, by structured Software Systems, Inc. retrieved from www.strsoft.com/intro/index.html describes a system for developing, testing, and executing automated trading systems based on a block diagram structure.

Whereas the two approaches described above define a trading system as a sequence of evaluations that must be made, the building block approach defines a trading system by interconnected components. Each component has a specific behaviour, i.e. it produces a well-defined output given a specified input.

Even though the above prior art system utilises a graphical representation of a trading system, the representation as block diagrams may still become rather complex and difficult to read for a typical user of such a system, especially when the trading system is complex and includes many rules.

Patent Application WO 03/065258 A2 describes yet another way of defining a trading system, by means of selecting the graphical representation of the financial instrument and the graphical representation of an information analysis tool, and applying a comparative condition on the graphical representations. This enables an action to be taken on said financial instrument depending on the future movement thereof.

The premise of this prior art method is that the price movement of a financial instrument can be drawn on a chart, together with other lines. Those other lines could either be drawn manually or automatically on the basis of some formula, for example a well known financial study, such as the Simple Moving Average. The user can now specify that some action must be carried out, based on a given relationship between the line representing the financial instrument, and the other lines, also specified by the user.

Even though this approach may work well for simpler systems, it remains a problem to provide a system that is suitable for more complex systems involving many conditions, or systems which are based on detecting a series of state changes.

Another problem related to the prior art is the issue of debugging a trading system to find out what it is actually doing given a particular input.

In the scripting language approach, this is relatively difficult to do. The user can open up the trading system specification in a debugger, and put break points into the script. However, the values of all variables in the script vary for each tick in prices, so it can become very tedious to specify when the script should actually be stopped, so relevant system variables can be investigated. This again is a discipline normally only mastered by users with a software development background.

The above described flow diagram approach does not allow debugging information to be displayed in an intuitive fashion.

Consequently, in the above prior art systems the creation, debugging and maintenance of trading systems is a complex and time consuming task. Furthermore, the creation and maintenance of complex trading systems may be error prone, e.g. caused by an erroneous layout or interconnection of blocks in a large block diagram or the like. Such errors may further be difficult to locate, thus involving the risk that a trading systems with undesired behaviour or even errors are used for live trading with the risk of great financial losses.

### SUMMARY

In embodiments of the invention, a computer-implemented tool is provided for facilitating definition of a financial trading system. In embodiments of the invention a financial trading system is defined by connecting building blocks into a diagram on a drawing pane, e.g. on a screen of a computer terminal. Each building block represents a system component of a system of interacting components. The connections between components are represent data flow between the components. The drawing pane is divided into distinct areas/sub-panes, each reserved for a predetermined type of components. Hence, the tool is adapted to restrict the user-controlled placement of components so as to allow the user to place components of each type of components in a sub-pane of the user-interface that corresponds to the component type.

In some embodiments of the invention the tool includes some or all of the following types of system components:
Signal generators: A signal generator component represents an instrument property (such as price, volume, open interest etc) over time.)
Filters: A filter takes as input at least one signal, and generates as an output at least one signal. Filters transform inputs to produce the output. The output of a filter can either be an analog value (i.e. a number) or a binary value (i.e. true/false). Examples of filters include any type of study known as such within the financial community as well as any other mathematical transformation, including but not limited to those commonly used in the field of digital signal processing.
Simple comparison blocks: A simple comparison block takes as input at least two signals, and produces as output at least one signal. The purpose of the simple comparison block is to compare the values or other properties of the input signals and from that comparison produce the output signal(s).
Condition blocks: One embodiment of a condition block lists two expressions and one comparison operator. The condition block takes no direct logical inputs, but produces one digital output. An example of a condition block is:
   “[SMA(50,Close)<SMA(200,Close)]”. The expressions listed on each side in the condition block can be of any complexity and include any instrument property, any financial study derived from any instrument property, as well as any other mathematical transformation based on any instrument property.
Combination blocks: Combination blocks take as input at least two digital signals and produces one digital output. An example of a combination block is the AND block.
Action blocks: Actions blocks have exactly one digital input. Action blocks take action specified when their input is true. Actions include any action related to a financial transaction, including the placement, change, and cancellation of orders and trades. Actions could also include any other action possibly triggered by a computer, including sending notifications (email, sms, pop up alerts), automatically generating trading suggestions, etc.

For the purpose of the present description, the terms “comparison operator” and comparison operation include comparisons of numerical values including “larger than”, “smaller than”, “equal to”, etc. as well as more complex comparison operations comparing properties of curves or time series. Examples of such comparison operations include ‘crosses above’ or ‘crosses below’ operations or the like.

In embodiments of the invention, a user can thus define a trading system by selecting and configuring several blocks of the types described above and connecting them. A suitably programmed computer may thus interpret, parse and/or compile the graphical interpretation of the trading system and execute the trading system based on suitable input data/signals.

In one embodiment, the system includes condition blocks, combination blocks and action blocks, and the drawing pane includes three sub-panes arranged next to each other such that each distinct sub-pane is reserved for a corresponding type of component, e.g. conditions to the left, combinations in the middle, actions to the right. This makes it easier for the user to organize the trading system. If the trading system is limited to a small number of different component types, e.g. the above three component types, a particularly easy-to-use system is provided.

In some embodiments, the user interface includes two selectable drawing panes, each drawing pane having a corresponding number of sub-panes, each sub-pane being reserved for a corresponding type of components. One drawing pane is assigned for defining the ‘entry’ strategy (for entering into the trade) and another drawing pane is assigned for defining the ‘exit’ strategy, i.e. for getting out of the trade again. The drawing panes may be selectable by a suitable active user-interface control element, such as a tab. Again this helps the user to organize a trading system in a structured way.

In some embodiments, the tool allows an execution of the trading system in a debugging mode. During debugging the tool displays a diagram of the trading system to be debugged. Each component of the trading system includes a state indicator. During debugging, the user is able to ‘step through time’, e.g. by triggering the next time step by a suitable control element of the control system, e.g. a button or the like, or by controlling the system to perform the time steps at predetermined time intervals. At any point the diagram can show the state of all components, which greatly improves the debugging process. Examples of the state of a component include the value of the expressions contributing to a condition block and the output of a condition or combination block. This is also an advantageous feature when educating new users to the concept of system trading.

It will be appreciated that the method and system described herein may be used in connection with many different financial instruments, such as a currency, a contract for difference, a stock, a future, an option, a commodity and/or the like.

The present invention relates to different aspects including the system described above and in the following, corresponding methods, devices, data processing systems, and computer programs, each yielding one or more of the benefits and advantages described in connection with the above-mentioned system, and each having one or more embodiments corresponding to the embodiments described in connection with the above-mentioned system.

According to one aspect, a computer-implemented method of generating a computer-executable financial trading strategy comprises:
arranging interconnectable building blocks into a diagram on a drawing pane provided by a graphical user interface for defining a financial trading strategy, each building block representing a functional system component of the financial trading strategy; wherein arranging comprises placing building blocks of different types in respective sub-panes, each for receiving a corresponding type of building block;
interconnecting the building blocks by lines indicative of a signal flow between interconnected building blocks;
translating the diagram of interconnected building blocks into computer-implemented instructions for executing the financial trading strategy.

It is noted that the features of the system and method described above and in the following may be implemented in software and carried out on a data processing device or other processing means caused by the execution of program code means such as computer-executable instructions. Here and in the following, the term processing means comprises any circuit and/or device suitably adapted to perform the above functions. In particular, the above term comprises general- or special-purpose programmable microprocessors, Digital Signal Processors (DSP), Application Specific Integrated Circuits (ASIC), Programmable Logic Arrays (PLA), Field Programmable Gate Arrays (FPGA), special purpose electronic circuits, etc., or a combination thereof. In particular, in some embodiments, different parts of the computer program code may be executed on different computers, e.g. a client system and a host system.

For example, the program code means may be loaded in a memory, such as a RAM (Random Access Memory), from a storage medium or from another computer via a computer network. Alternatively, the described features may be implemented by hardwired circuitry instead of software or in combination with software.

According to one aspect, a data processing system is suitably configured to perform the steps of the method described above and in the following.

According to another aspect, a computer program comprises computer-executable instructions adapted to cause, when executed on a data processing system, the data processing system to perform the method described above and in the following.

In some embodiments, the computer program product comprises a computer-readable medium having stored thereon the computer-executable instructions. In other embodiments, the computer program product is embodied as a data signal, e.g. a suitably modulated carrier signal.

For the purpose of the present description, the terms storage means and computer-readable medium are intended to comprise any suitable storage medium, device or circuit, e.g. a read-only-memory (ROM), a random access memory (RAM), a flash memory, an Erasable Programmable Read-Only Memory (EPROM), volatile or non-volatile memory, an optical storage device, a magnetic storage device, a diskette, a CD, a hard disk, or the like.

### BRIEF DESCRIPTION OF THE DRAWINGS

The above and other aspects will be apparent and elucidated from the embodiments described in the following with reference to the drawings, in which:

FIG. 1 schematically shows a flow diagram representation of an example of a trading system.

FIG. 2 schematically shows a computer system for creating and executing a financial trading system.

FIG. 3 shows a user-interface of a computer-implemented tool for defining a financial trading system.

FIG. 4 illustrates a process of defining an entry strategy of a trading system by means of a user-interface of a computer-implemented tool for defining a financial trading system.

FIG. 5 illustrates a user-interface of a computer-implemented tool for defining an exit strategy of a financial trading system.

FIG. 6 illustrates a user-interface of a computer-implemented tool for defining overall properties of a trading system.

FIG. 7 illustrates a user-interface of a computer-implemented tool for testing/debugging a defined financial trading system.

FIG. 8 illustrates a process of back testing an instance of trading system by means of a user-interface of a computer-implemented tool for selecting a predefined trading system, and specifying a financial instrument chart, various configuration settings, and a period over which the back test should be performed.

FIG. 9 illustrates a user-interface of a computer-implemented tool for submitting an instance of a financial trading system, for live execution, thus potentially trading automatically on behalf on the user, for real money.

FIG. 10 illustrates another example of a user-interface of a computer-implemented tool for defining a financial trading system.

FIG. 11 illustrates an example of a user interface for defining variables for use in the definition of a trading system.

FIG. 12 shows another example of a user-interface of a computer implemented tool for defining a financial trading system.

FIGS. 13-14 show an example of a user-interface of a computer implemented tool for optimizing a financial trading system.

FIG. 15 illustrates a block diagram definition of a study for use in a condition block.

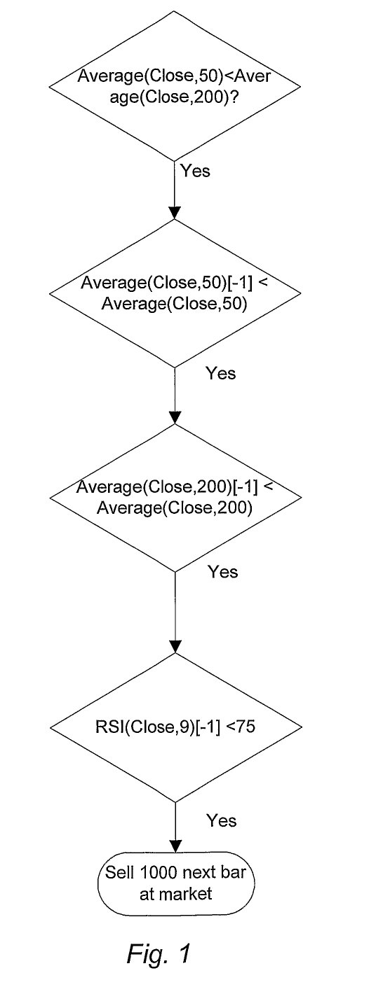

### DETAILED DESCRIPTION OF PREFERRED EMBODIMENTS

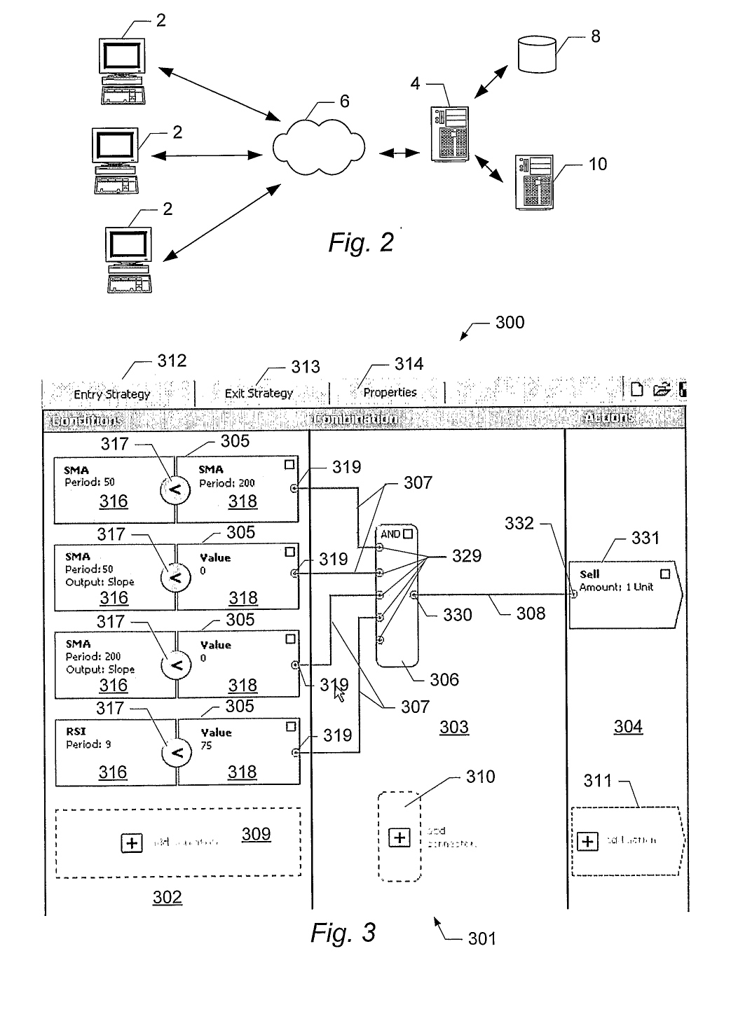

FIG. 2 schematically shows a computer system for creating and executing a financial trading system. The system of FIG. 2 includes user or client systems 2. Each user system 2 may be implemented using a general-purpose computer executing a suitable computer program for carrying out the processes described herein. A user system 2 may be a personal computer operated by a trader engaged in trading one or more financial instruments. User system 2 may also be a mobile device such as a mobile telephone, a handheld computer, a PDA, or other digital device with a display, controls, and a network or wireless connection.

A host system 4 is in communication with the user systems 2 through network 6. The host system 4 may be implemented using servers and executes a computer program for carrying out the processes described herein. Host system 4 may further serve as a central location for defined trading systems, trading system templates, etc.

The network 6 may be any type of known network including a local area network (LAN), wide area network (WAN), global network (e.g., Internet), intranet, etc. The user system 2 may be coupled to the host system 4 through multiple networks (e.g., intranet and Internet) so that not all user systems 2 are coupled to the host system 4 via the same network. One or both of the user systems 2 and the host system 4 may be connected to the network 6 in a wireless fashion and network 6 may be a wireless network. In one embodiment, the network 6 is the Internet and each user system 2 executes a user interface application (e.g., web browser) to contact the host system 4 through the network 6. Alternatively, a user system 2 may be implemented using a device programmed primarily for accessing network 6 such as a remote terminal.

The host system 4 may operate as a network server (often referred to as a web server) to communicate with the user systems 2. The host system 4 handles sending and receiving information to and from user systems 2 and can perform associated tasks. The host system 4 may also include a firewall to prevent unauthorized access to the host system 4 and enforce any limitations on authorized access. For instance, an administrator may have access to the entire system and have authority to modify portions of the system. The firewall may be implemented using conventional hardware and/or software as is known in the art.

The host system 4 may also operate as an applications server. The host system 4 executes one or more computer programs to perform processes such as generating, debugging, executing, storing, manipulating, trading systems. The host system 4 may further execute a software application for performing trading transactions, e.g. including receiving trade data related to financial instruments, transmitting trade orders for initiating the selling and/or buying of a financial instruments, etc.

The host system 4 may further interact with other systems 10, e.g. for receiving or outputting information related to trading information that may serve as inputs to the defined trading systems, and/or for performing trade transactions. An example of such a system may include an application server providing an STP (Straight Through Processing) capability, thus enabling automatic routing of orders to external financial entities including exchanges.

It is understood that separate servers may be used to implement the network server functions and the applications server functions. Alternatively, the network server, firewall and the applications server can be implemented by a single server executing computer programs to perform the requisite functions.

Furthermore, in alternative embodiments, some or all of the user systems 2 may include the functionality of host system 4. Hence, such user systems may execute trading systems and optionally even initiate trading transactions directly.

Storage device 8 may be implemented using a variety of devices for storing electronic information such as a database server, a file transfer protocol (FTP) server, or the like. It is understood that storage device 8 may be implemented using memory contained in host system 4 or may be a separate physical device. Storage device 8 has stored thereon a variety of information related to the trading transactions and the trading systems.

It is understood that the invention may be implemented by different computer-systems. For example, the entire process described herein may be executed on a single computer, e.g. a user computer or user computer system. In yet another embodiment, the system may be implemented as a distributed system, e.g. a peer-to-peer system, of a plurality of user computers.

Operation of the system will now be described with reference to FIGS. 3-15.

As mentioned above, in embodiments of the present invention a software application, e.g. a single computer program or a suite of programs, is provided for defining, testing, and executing a trading system by connecting components, in particular graphical components of a graphical user interface. Each component represents a specific behaviour, i.e. it produces a well defined output given a specified input. Significant improvements in usability can be achieved by defining a financial trading system using a model of interacting components (building blocks).

In one embodiment, the software application provides a graphical user-interface, e.g. a windows-based user interface, for defining a trading system as described in connection with FIGS. 3-6.

FIG. 3 shows a user-interface of a computer-implemented tool for defining a financial trading system. The user-interface, generally designated 300, includes a drawing pane 301 that is divided into three distinct sub-panes or panes 302, 303, and 304. The sub-panes are arranged side by side in columns, each sub-pane is arranged to accommodate/receive a corresponding type of system components of a trading systems. Sub-pane 302 is configured to include condition blocks 305; sub-pane 303 is configured to include logical combination blocks 306, and sub-pane 304 is configured to include action blocks 331. The blocks are connected by data flow lines 307 and 308, respectively, defining a data flow from left to right from condition blocks via one or more combination blocks to one or more action blocks.

In the example of FIG. 3, the sub-panes are arranged side by side as columns such that the logical information flow is from left to right. However, it will be appreciated that other arrangements are possible, e.g. an arrangement in rows e.g. such that the logical information flow is from top to bottom, or as concentric rings such that the information flow is radially outward.

Each of the sub-panes 302, 303, and 304 includes an active control element 309, 310, and 311, respectively allowing a user to add component blocks of the corresponding type to the respective sub-panes, thereby enforcing the correct placements of component blocks in the corresponding panes.

The user interface further includes a tab strip with tabs 312 and 313 for selecting/activating alternative drawing panes and tab 314 for selecting a properties pane. The drawing pane 301 shown in FIG. 3 is the drawing pane for defining an entry strategy of the trading system, i.e. the conditional rules for entering a trade in a financial instrument. This pane is activated/selected by selecting tab 313. Selecting tab 312 causes a drawing pane for defining an exit strategy of the trading system to be invoked, i.e. a corresponding pane for defining the conditional rules for exiting a trade in a predetermined financial instrument.

Each condition block 305 includes four main elements:
a first element 316 representing a first quantity/data signal (also referred to as left-hand comparison),
a second element 317 representing an operator, e.g. greater than, less than, equal to, not equal to, crosses from below, crosses from above, etc.
a third element 318 representing a second quantity/data signal (also referred to as right-hand comparison), and
an output terminal 319 representing a Boolean/binary data result indicative of whether the comparison defined by the first quantity, the operator, and the second quantity is true or false.

Each combination block 306 has two or more input terminals 329 and one output terminal 330. Each combination block represents a logic operation to be performed on the inputs and resulting in a Boolean/binary output.

It will be appreciated that in some embodiments the system may include alternative or additional types of combination blocks. Further examples of combination blocks will be described below.

Each action block 331 has an input terminal 332 for receiving a Boolean/binary input, and each action block represents an action which the software application is caused to perform responsive to the Boolean input 332.

In some embodiments several action blocks may be interconnected as a chain of several action blocks, so that if the first block is executed, then all following action blocks will be executed as well.

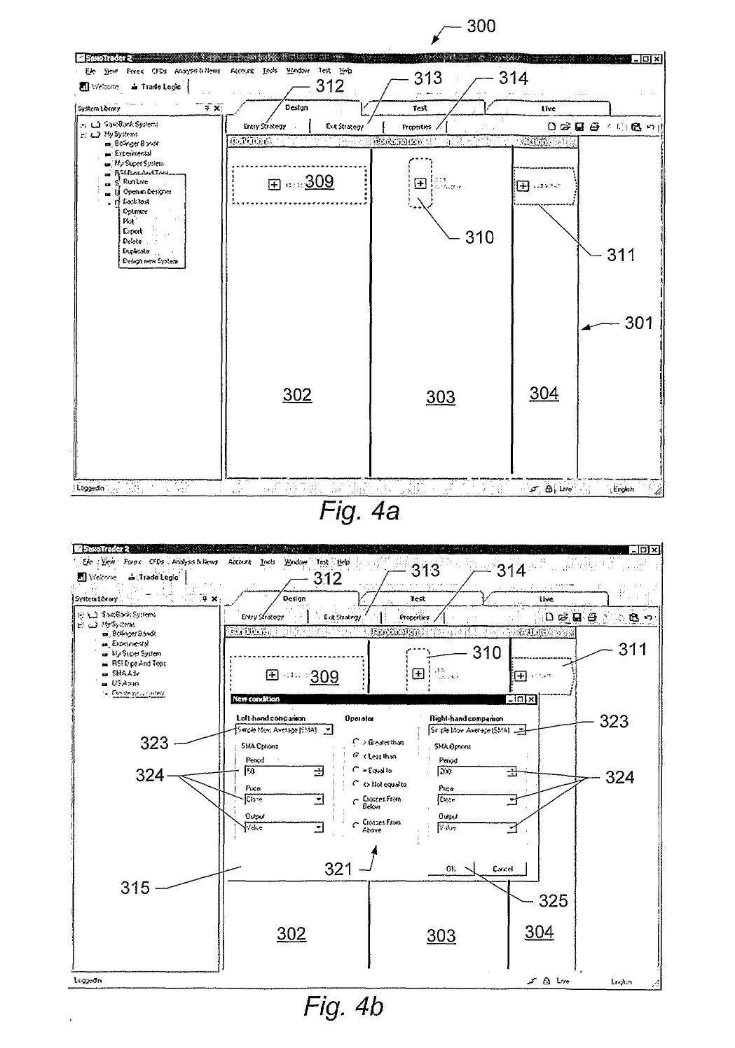

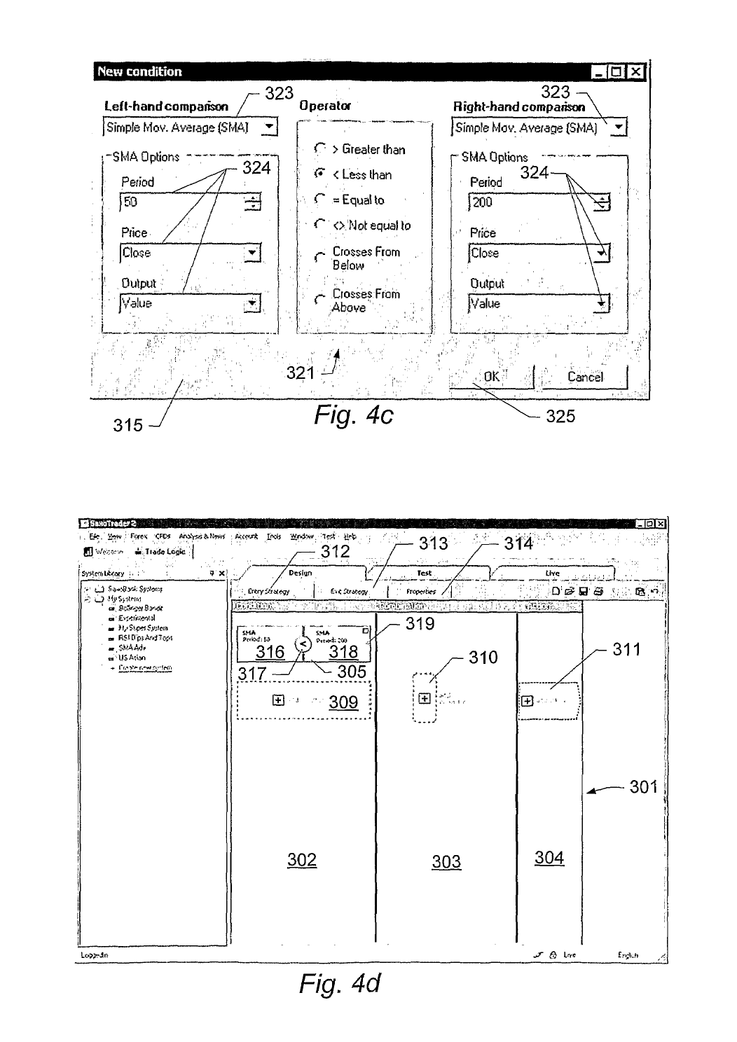

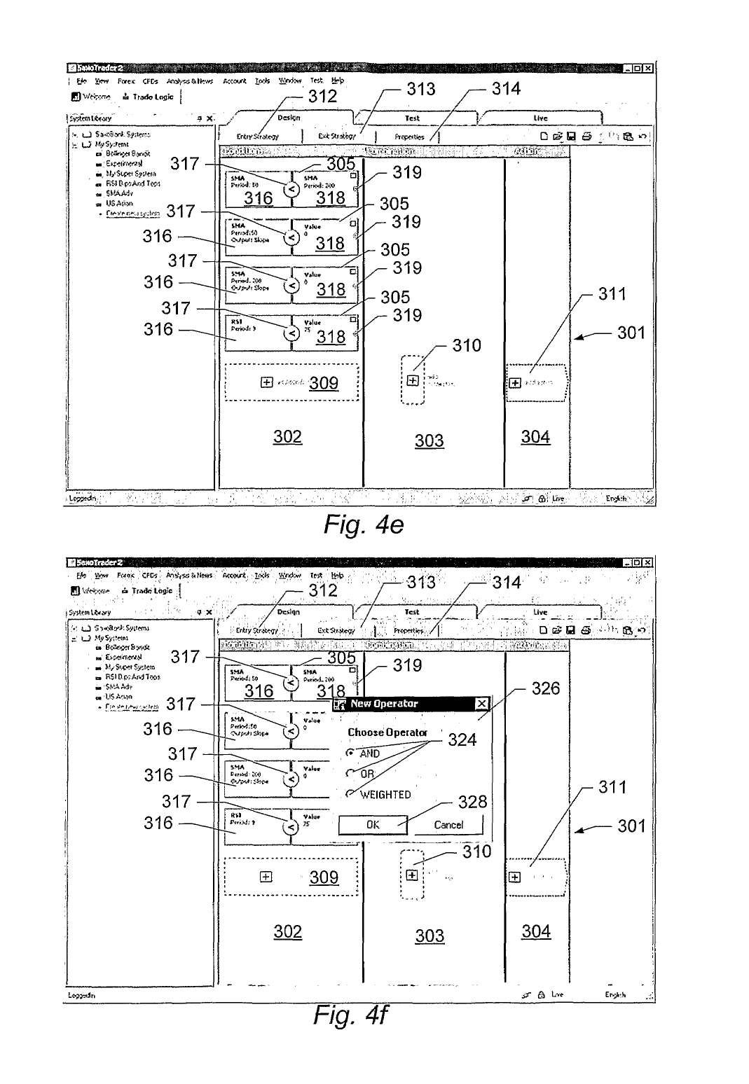

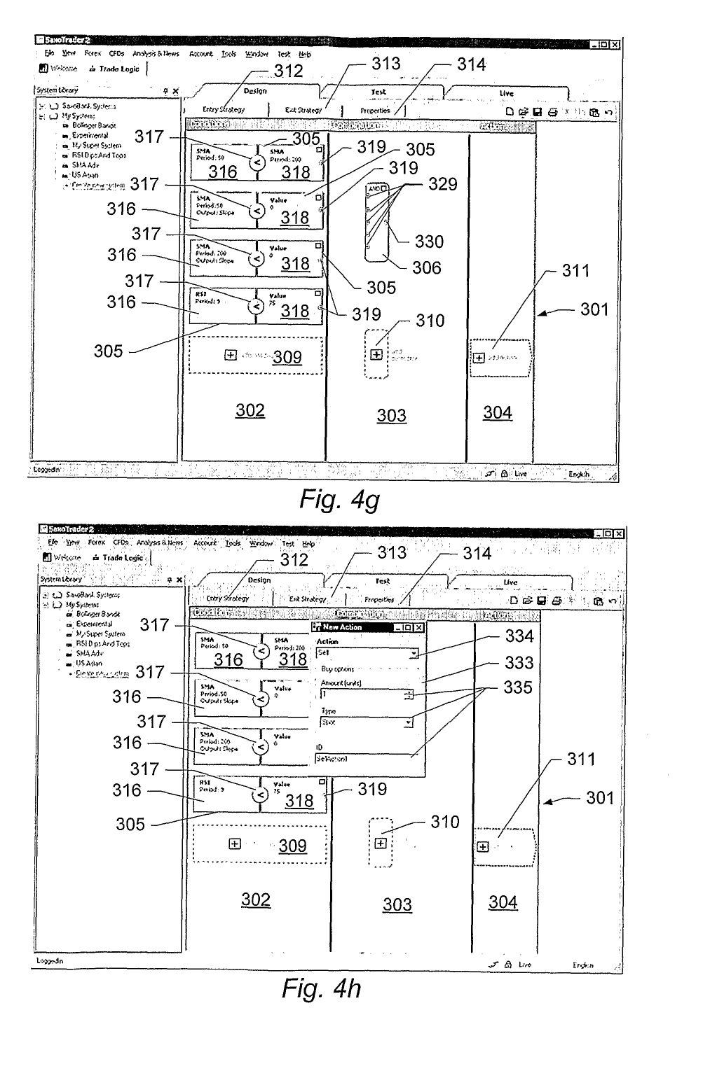

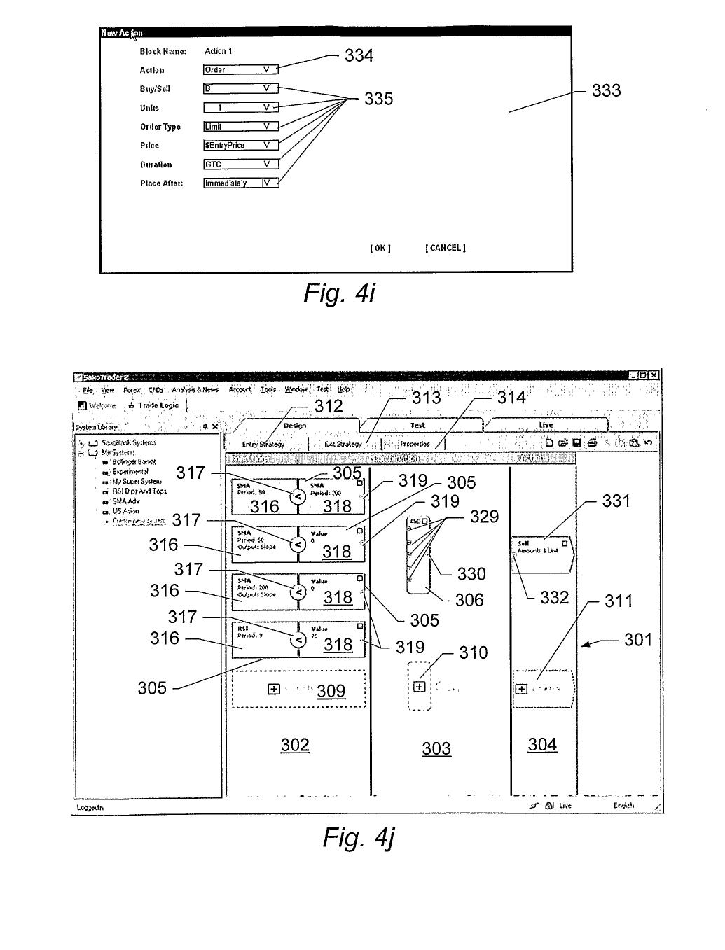

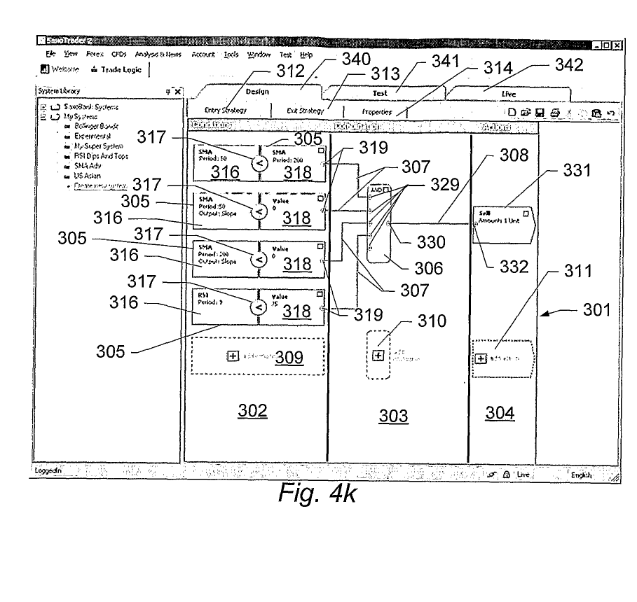

FIG. 4 illustrates a process of defining an entry strategy of a trading system by means of a user-interface of a computer-implemented tool for defining a financial trading system.

The definition process is initiated by the user selecting a “design new system” option, e.g. from a pull-down menu. The system initially shows an empty drawing pane 301 with sub-panes 302, 303, and 304 for condition blocks, combination blocks and action blocks, respectively. Initially, the panes do not yet include any components, but only control elements 309, 310, and 311 for adding the respective components blocks, as illustrated by FIG. 4a.

The condition blocks 305 in the left sub-pane 302 represent conditions: The user specifies conditions by clicking the ‘Add condition’ icon/button 309 at the bottom of the left column 302. This causes the system to bring up a dialog box 315 from where the user can specify which condition the user wants to define. FIG. 4b shows the user interface with an example of a dialog box 315 invoked, while FIG. 4c shows an enlarged view of the dialog box 315. The dialog box includes control elements for defining the first, second, and third element of the condition block, respectively.

For each side of the condition, the user specifies the expression to be evaluated. An expression may be a property related to a financial instrument, such as the open, high, low or close price of the instrument, the volume traded, whether or not the instrument is currently tradable etc. An expression may also be any public of proprietary financial study, such as ‘Simple Moving Average, SMA’, ‘Relative Strength Index, RSI’, ‘Parabolic SAR, PSAR’ etc. Further an expression may comprise information related to the state of trading system itself, as it is being executed. One example of system state could be ‘how long since the system entered a position’. Another example of system state could be the value of a variable, for example a counter used to keep track of how many times something has happened. Further an expression may also comprise a combination of any of the above individual expressions.

The user selects the type of expression from a list 323 of instrument properties and studies. Once the property or study has been selected, the user dialog changes dynamically so as to present additional control elements 324 for allowing the user to set parameters specifically pertaining to the type of expression selected. The dialog box further includes option buttons 321 allowing the user to select an operator from a list of possible operators. In the example of FIG. 4b, the dialog box 315 is shown after a user selection corresponding to the following condition: A 50-day simple moving average is less than the 200 day simple moving average. After pressing an OK button 325, the dialog disappears, and the user interface displays the corresponding condition block 305 as shown in FIG. 4d. The condition block has a left-hand text field 316 indicating the property/study selected as the first element of the comparison and a right-hand text field 318 indicating the property/study selected as the second element. The condition block 305 further includes a symbol 317 indicating the operator of the condition.

By repeating the steps described in connection with FIGS. 4a-d, the user can add further condition blocks, e.g. as shown in FIG. 4e, where the user has added four condition blocks representing different conditions.

By adding blocks in the middle pane 303 of the screen the user can define how these conditions should be combined. Blocks in the middle are called “combination blocks”. The user can add one or more combination blocks by pressing the “add combination” button 310 at the bottom of the middle column 303. This brings up a dialog box 326 as shown in FIG. 4f.

The dialog box 326 includes a number of option buttons 327 allowing the user to select how the system should combine the output from the condition blocks. For example:
An AND block will output ‘true’ if all inputs to the block are true.
An OR block will output ‘true’ if just one of the inputs to the block are true.
A “Weighted Or” block will assign weights to each input and the output will be true if the weights assigned to all inputs which are true is greater than a predefined threshold.

When the user has selected an option button and has pressed the OK button 328, the dialog box 326 disappears, and the user interface displays the corresponding combination block 306 as shown in FIG. 4g. By repeating the steps described in connection with FIGS. 4e-g, the user can add further combination blocks representing different conditions.

In the next step, the user specifies which action(s) to be taken by adding one or more Action blocks 331. To this end the user clicks the ‘Add Action’ icon 311 at the bottom of the right pane 304 of the screen. Doing this causes the system to bring up a dialog box 333 as shown in FIG. 4h.

The user can select a number of different actions. Some actions pertain directly to initiation of a financial transaction. This includes placing a single or several related orders of varying types and durations for some number of contracts of a financial instrument. For example the action may specify the placement of an at market order to buy 10 contracts of an instrument. Or the action may specify to place a sell limit order for 5 contracts on an instrument at a specified limit price, the limit price being defined either directly as a number, “1.275”, or indirectly in the form of an expression derived from the current state of the trading system, such as ‘entry price’ +0.05. Additionally the user may specify several related orders, within one condition block. This is typically done, to concurrently specify one order to potentially enter a trade, along with one related limit order to take profit if a certain advantageous price level has been reached, and an additional related stop order to close the trade, if it goes against the trader.

Other types of actions can be categorized as alerts. Alerts may be in the form of emails, SMS messages, Instant Message messages, pop up messages on the users' personal computer as well as any audible alert.

Other types of actions are aimed at changing the state of currently running trading system. In particular an ‘Assign’ action block provides a simple text editor, in which the user may write in lines of assign statements to set the value of a trading system variable, as will be described in greater detail below.

The action type is selected by using a drop down menu 334 or some other means of selector. Once the action has been selected, the dialog box changes and includes suitable control elements 335 for selecting parameters pertaining to that specific action, e.g. by selecting from a list of possible options. Examples of possible parameters include the quantity of instruments to buy or sell, the order type, the price, etc. It will be appreciated that some of the parameters may be specified explicitly, e.g. by specifying a number or the like, while others may be specified by a variable, e.g. a variable indicating a specific price.

FIG. 4i shows another example of an action dialog box 333. After closing the dialog box 333, the user interface displays the corresponding action block 331 as shown in FIG. 4j. By repeating the steps described in connection with FIGS. 4g-j, the user can add further action blocks representing different actions.

Finally, the user can connect the different blocks with each other by data flow lines 307 connecting the output terminals of the condition blocks with input terminals of the combination blocks and/or action blocks and by corresponding data flow lines 308 combining an output terminal of a combination block with an input terminal of an action block so as to define the trading system behaviour, i.e. which comparisons should be combined to trigger which action. Further it is possible to connect a terminal of one action block to terminal of another action block, so that both blocks will be executed if the input to the first block is true.

The blocks may e.g. be connected by a click and drag operation with a pointing device, or the like. An example of the thus completed trading system is shown in FIG. 4k.

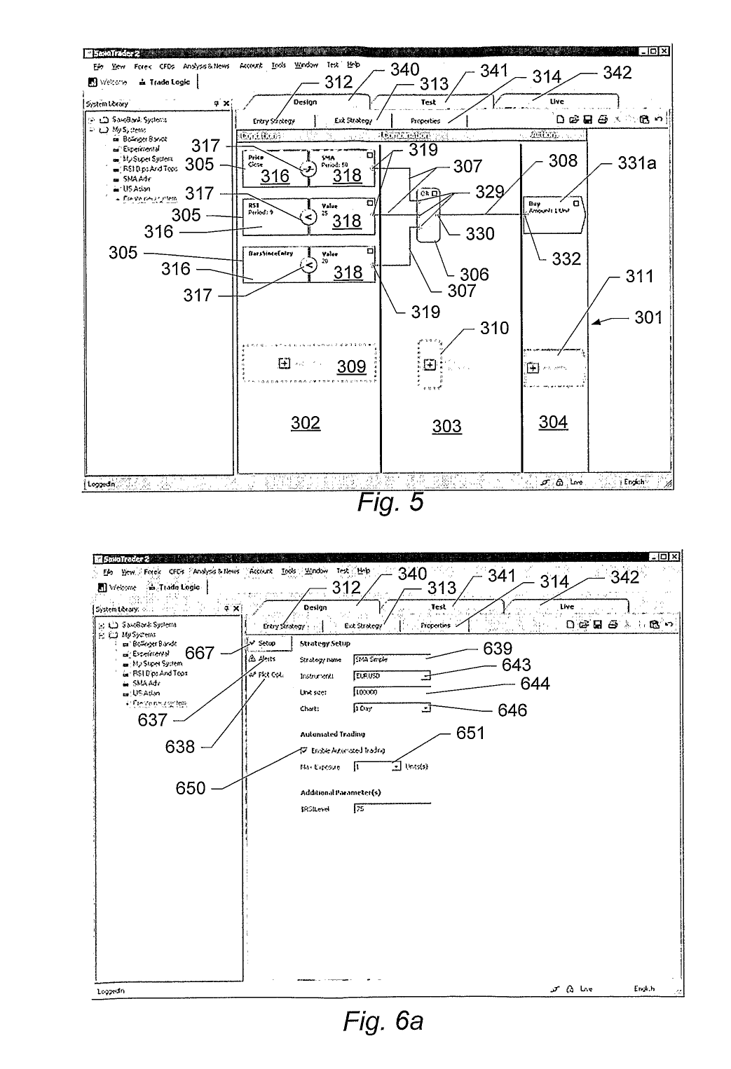

FIG. 5 illustrates a user-interface of a computer-implemented tool for defining an exit strategy of a financial trading system. The user-interface is invoked by a user action, e.g. selecting the “exit strategy” tab 312. The user-interface for defining an exit strategy has a similar structure and functionality as the interface described in connection with FIGS. 3-4. In particular, the user interface also includes a drawing pane 301 including three distinct sub-panes 302, 303, 304 for defining condition blocks 305, combination blocks 306, and action blocks 331, as described in connection with FIGS. 3-4. Accordingly, the process for defining an exit strategy corresponds to the process for defining an entry strategy described in connection with FIG. 4.

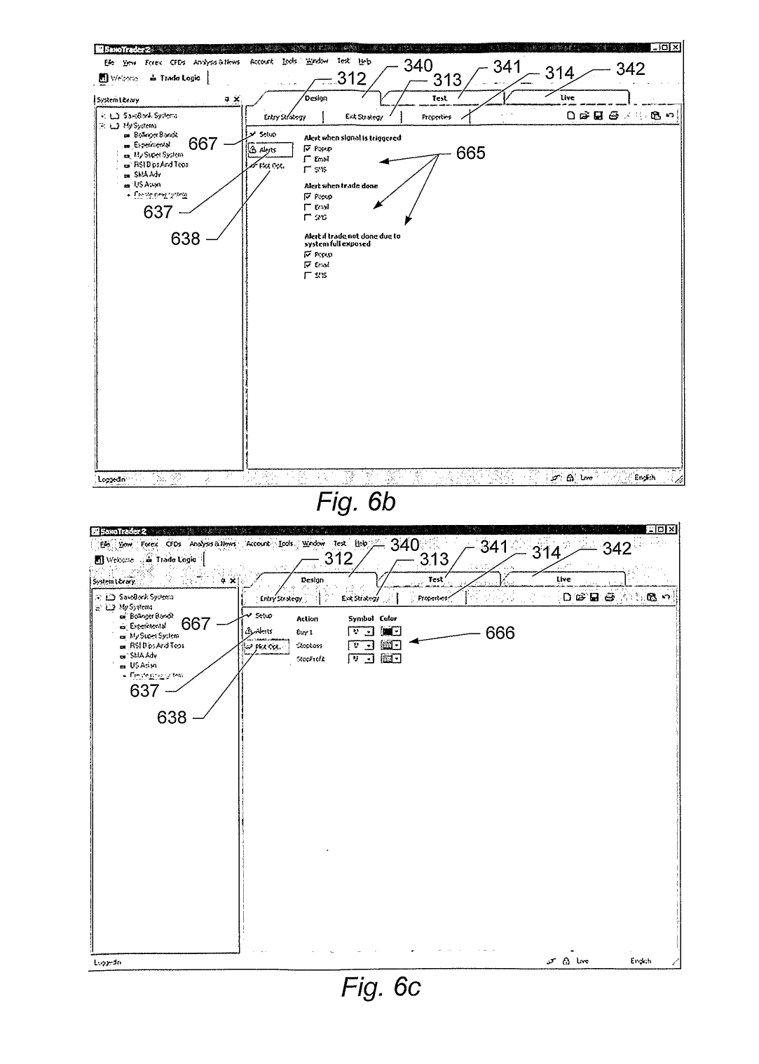

FIG. 6 illustrates a user-interface of a computer-implemented tool for defining default values for the overall properties of a trading system. The user-interface is invoked by a user action, e.g. selecting the “properties” tab 314. The user interface provides a number of control elements for selecting overall properties 667 of the trading system, the setting up of alerts 637, and the setting up of plot options 638.

Selecting the general setup pane 667 allows a user to specify a trading system name 639 and/or identifier of the trading system allowing subsequent retrieval in a database/repository of trading systems. Additionally the user may select default values of the specific financial instrument 643 on which the trading system is to be applied, a default unit size 644 applicable to the buy and sell actions, the default time scale for the instrument chart 646, and/or the like. The user interface further allows the user to enable automatic trading, as default, by checking an appropriate checkbox 650. When automatic trading is enabled, the trading system, when executed on a computer configured to engage in automatic trading, causes the computer to initiate the buy and/or sell actions defined by the respective action blocks, when the respective combinations of conditions are fulfilled. The user-interface may further include control elements for specifying additional parameters related to the automatic trading, such as a maximum exposure value 651, as well as the initial value of any trading system defined variable.

Selecting the alerts pane 637 allows a user to setup alert parameters 665, in particular how the system should send an alert, e.g. as a pop-up dialog box, as an e-mail, as an SMS, or the like. The setup may be done separately for different types of alerts, e.g. alerts when a signal is triggered, an alert when a trade is done, or an alert if a trade is not done because the system is fully exposed.

Selecting the plot option pane allows a user to set plot options 666. Here the user may specify if, and how (by selecting an icon and a color) a specific action should be plotted on a financial chart, if that action is executed, in response to its input becoming true.

It will be appreciated that the benefit of the approach described herein is particularly pronounced when the system comprises many conditions and several AND/OR combinations resulting in several actions.

It will further be appreciated that the user may also edit already created blocks by clicking on the respective block which invokes the corresponding dialog box allowing the user to change the block settings.

It is an advantage of the method described herein that even users without a software background can confidently define a financial trading system:
As stated in the introduction, a trading system application should monitor relevant financial data. When it finds that a certain combination of certain conditions are fulfilled it should take certain actions.
This is exactly how the user specifies the system. The user first selects the relevant conditions by clicking the [Add Condition] button, selecting the property or study to be monitored along with any property or study specific settings.
The user then selects which combinations of the selected conditions should trigger an action. Again this is done simply by clicking an [Add combination] button and making simple selections from within a dialog pertaining to the selected combination.
The user selects one or more actions by clicking an [Add action] button and filling out a few action-specific parameters.
The user finally uses simple ‘drag and drop’ gestures to combine these blocks in an intuitive manner.

The end result of this ‘building block/component’ approach is that a user can specify quite advanced trading systems without having to write one line of code. Further a visual representation of the trading system is immediately available, making it easy to discuss the trading system with other users, without having to resort to looking at code/programming language.

The division of the screen in sub-panes for the different types of blocks enforces the definition of a clearly structured trading system and reduces possible sources or errors, e.g. by avoiding that the wrong blocks are connected to each other, avoiding circular flows, and the like. Furthermore a structured step-by-step definition process is facilitated.

The composition of a financial trading system as a set of interconnected blocks, further provides for the implementation for a very intuitive visualization of the system state, both while the system is being debugged, and when it is executed in real time, as will be discussed below.

Once the user has completed the definition of a new trading system or the editing of an existing trading system, the user may save the defined trading system. The block diagram may be stored as a suitable data structure, e.g. as a data structure including a plurality (e.g. a list) of data items, each representing a building block of the trading system, each building block data item representing the properties/parameters of the corresponding building block, information about the position of the building block within the corresponding sub-pane, and information about how the building block is interconnected to other building blocks.

Furthermore, the user may debug and/or execute a newly defined or a previously stored trading system. To this end, user interface 300 further includes a tab strip with tabs 340, 341, and 342 allowing a user to select different modes of operation of the system: when selecting tab 340, the system is operated in a design mode allowing the user to create new trading systems, and edit or debug a previously created trading.system.

The screens shown in FIG. 4 are all screens of an example of the design mode of a system for defining a trading system.

Selection of tab 341 causes the system to be back tested and optimized, while selection of tab 342 causes the system to be operated in live mode allowing a user to execute a trading system.

In some embodiments, the computer system for generating and/or executing the trading system may initially perform a compilation process. The compilation process parses/traverses the diagram of building blocks and generates corresponding computer-executable program code corresponding to the functions represented by the building blocks. The compiled trading system may then be stored and/or distributed as an executable program. In alternative embodiments, the computer system executing the trading system performs the execution directly on the basis of the data structure representing the diagram, e.g. by performing an interpretation process in connection with the execution.

A further advantage of the system described herein is that it is easy to debug such a system. During a debugging session the screen can easily be annotated with the value of all expressions and block outputs as they are (were) at a particular point in time.

This is illustrated in FIG. 7 which shows a user-interface of a computer-implemented tool for testing/debugging a defined financial trading system.

The debugging screen may be activated from a menu item, e.g. by invoking a dialog box for entering a number of setup parameters specifying a test scenario, and causing the system to show a test user-interface shown in FIG. 7. The debugging screen is structured similar to the design screen, i.e. showing three panes 302, 303, and 304 for the respective component blocks.

The debug screen further includes a number of control elements in the bottom of the screen. Using the bottom control the user can specify a start date for the debugging session. The trading system simulator will “rewind” the state of the trading system to the specified start date 745.

The user may then press a “Next” button 746 to slowly go forward in time, e.g. by stepping through time at a predetermined time steps. After every time step, execution of the trading system causes the system to receive incoming financial data indicative of the properties defined in the condition blocks, process the data according to the defined studies, perform the respective comparison operations 317 on the results 747 of the studies, combine the results, and perform the actions in the response to the combined results. At each time step the screen shows:
The values 747 of all the expressions used in the condition blocks 305a-d.
The output of all building blocks is represented by respective graphical indicators 748a-f associated with the respective building blocks, e.g. in the form of squares whose colour indicates the output of the block (TRUE/FALSE, e.g. green=TRUE and red=FALSE).

If for example the user is wondering why the trading system is ready to Sell at May 6, 2004 21:45 (as indicated by the time indicator 749), the user can verify that:
The square 748f in the Sell action block 331 is green indicating that the action is triggered,
Because its input coming from the And block 306 is green (748e) indicating that the AND condition is true,
Because the condition blocks 305a-d connected to the AND block 306 are all green (748a-d).

And if the user looks at one of the condition blocks, the user can further see that (e.g.) the top left block 305a is green because
The value at SMA 50 (the 50 day simple moving average) is 1.36 and
The value at SMA 200 (the 200 day simple moving average) is 1.38.

In one embodiment, a display showing the state of each trading system building block as it is during live execution is implemented. This makes it very easy for a user to observe if a trading system is ‘very close’ to initiating an action, and if so, which conditions needs still to be met, thereby providing a particularly user friendly and effective interface.

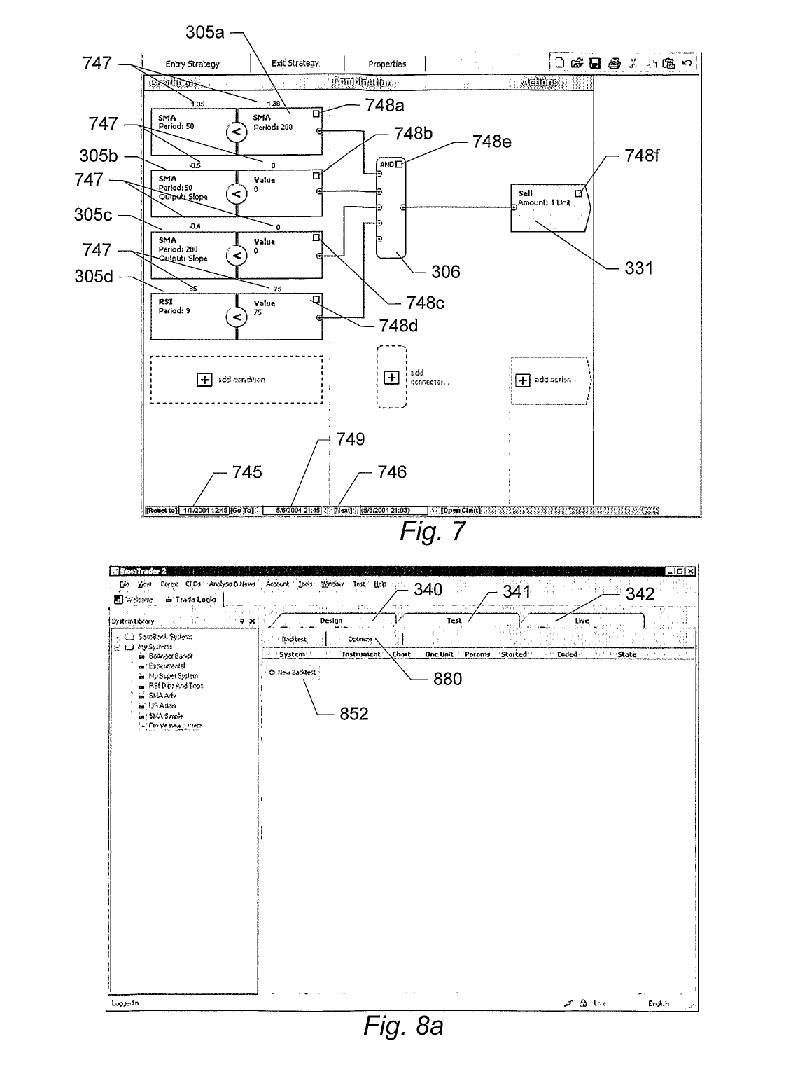

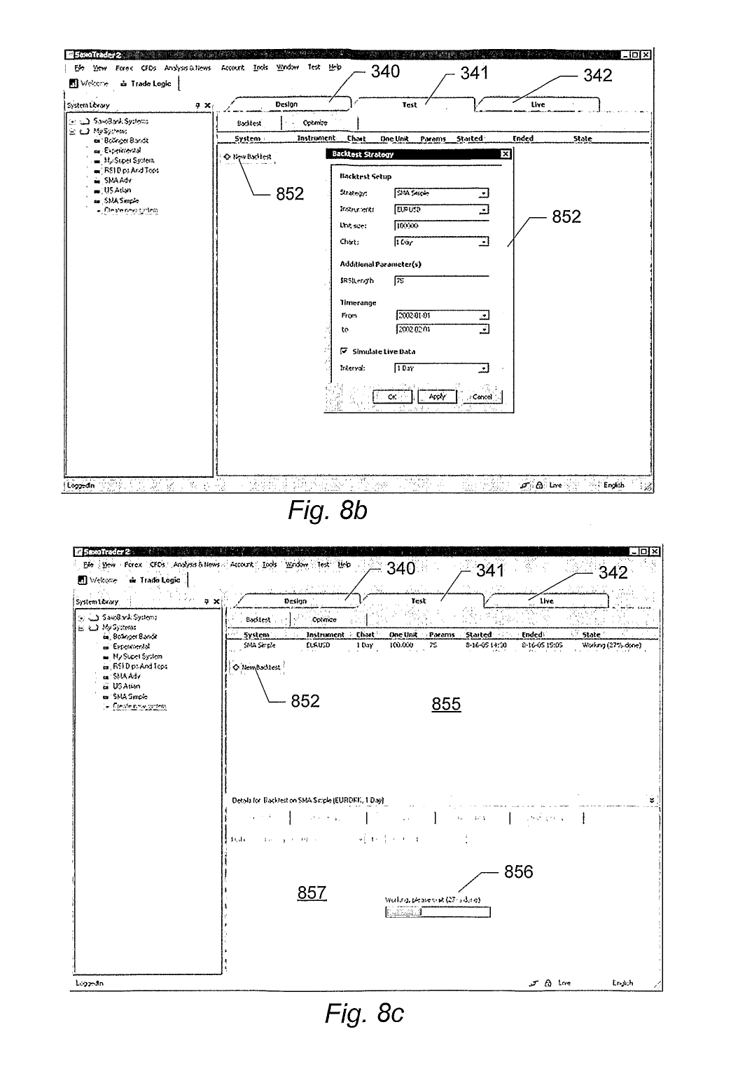

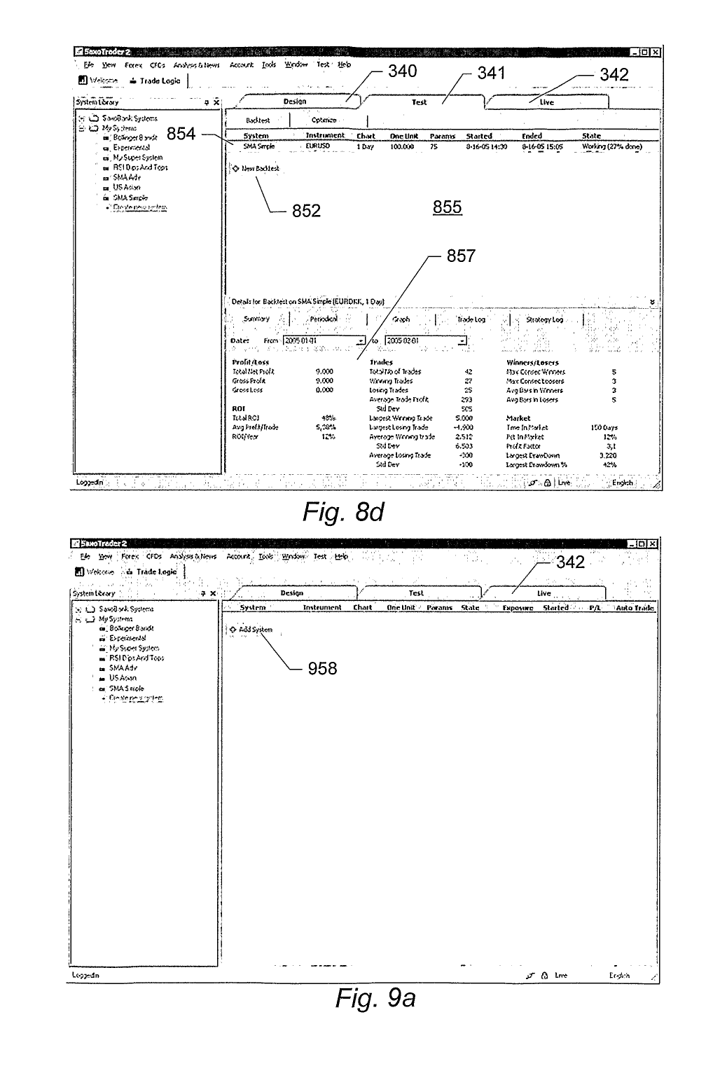

FIG. 8 shows another example of a user-interface of a computer-implemented tool for back testing a defined financial trading system.

The debugging screen of FIG. 8 allows the setting up of a backtest scenario, i.e. the testing on a set of historic trading data stored or retrieved by the computer system. The backtest functionality is activated by the user selecting the test tab 341, causing the system to show a test user-interface shown in FIG. 8. When no previous test scenario has been set up, a setup screen as shown in FIG. 8a appears, including an icon/button 852 for initiating the setup of a new test scenario. When the user activates button 852, the system invokes a dialogue box 853 as shown in FIG. 8b. The dialog box 853 provides input control elements for entering a number of setup parameter specifying a test scenario. Examples of such parameters may include the name of the trading system to execute, the financial instrument for which the trading system is to be tested on, the unit size for the simulated sell and buy actions, a time increment for the plotting of the results, a time range for which the backtest is to be applied, and/or additional or alternative parameters.

Upon acknowledgement of the entered parameters, the dialog box disappears and the backtest scenario appears as a new row 854 in a table of test scenarios in the upper pane 855 of the screen. In one embodiment, the test scenario is automatically executed as indicated by a status bar 856 in the lower pane 857 of the screen, i.e. the system inputs historic trading data for the specified financial instrument into the specified trading system, e.g. at simulated real-time, at predetermined discrete time steps, or the like. The trading system is executed and the resulting actions are logged. It will be understood that in this test mode, the system does not actually initiate automated trading, but merely logs which actions would have been taken at which times, if the input data were live data. Upon completion of the execution of the test scenario, the results of the backtest are displayed in the lower pane 857 of the screen. The results that may be displayed include test summary data, such as total profits/losses, return of investment, number of trades, etc. The user interface may further include control elements allowing the user to view detailed test results, such as a log of all simulated trades performed, various charts, and or the like.

It will be appreciated that the user may define more than one test scenario that are all displayed as respective rows in the upper pane. The lower pane then displays information about the selected/highlighted scenario.

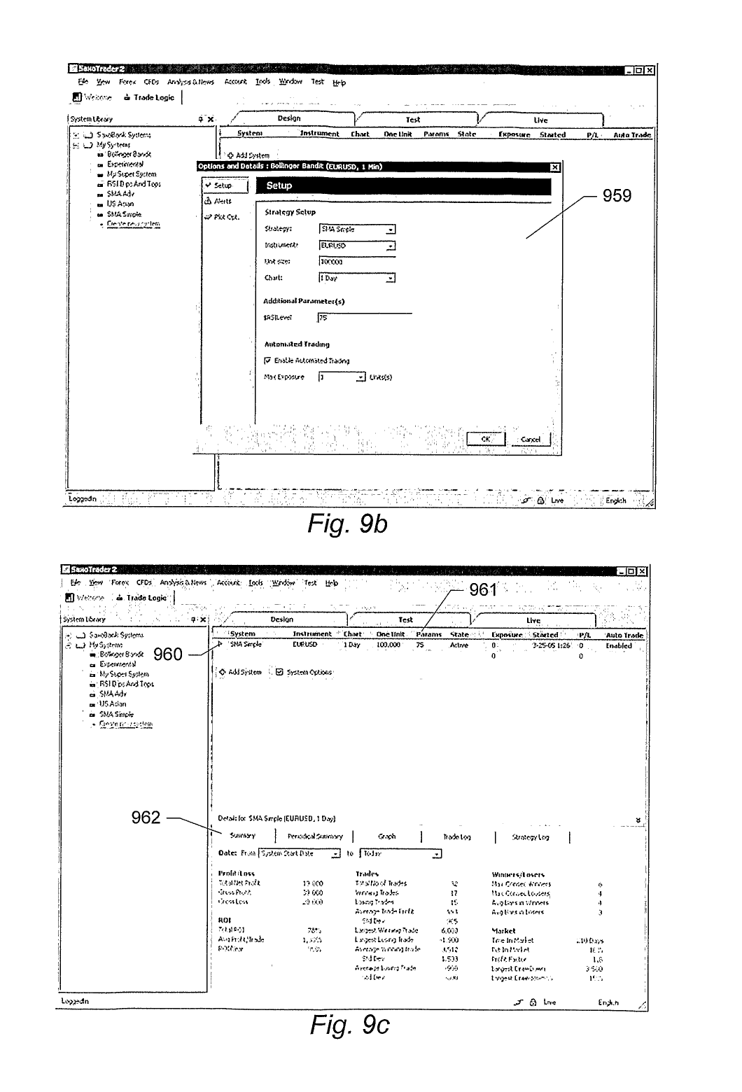

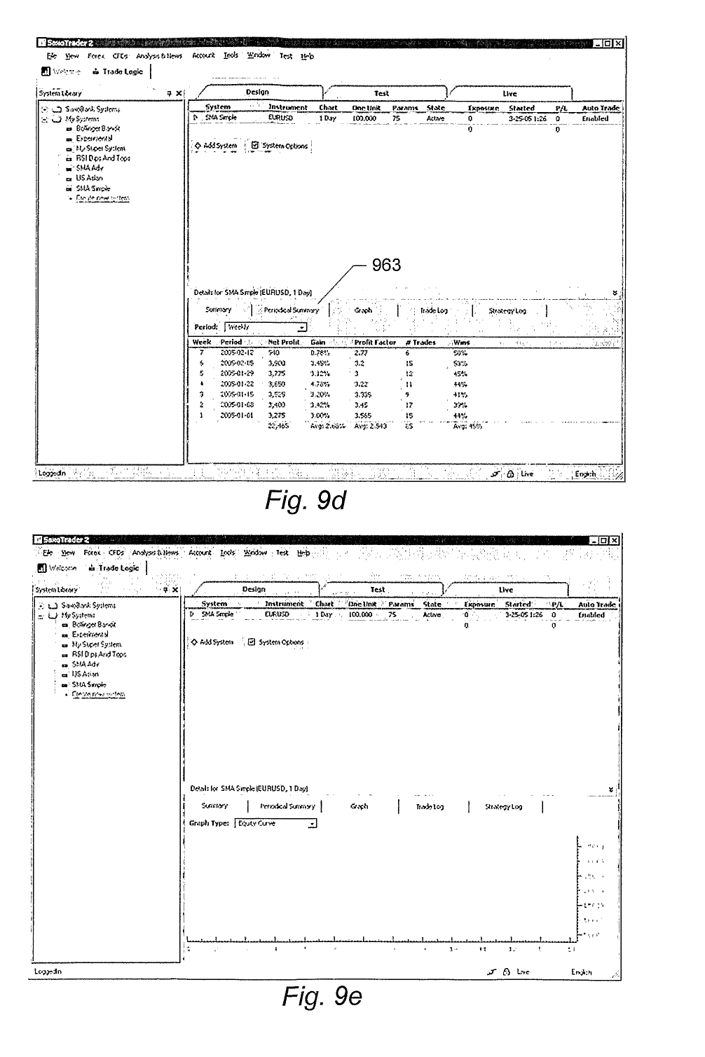

FIGS. 9a to 9c illustrate user interfaces facilitating the process of submitting a trading system for live execution, e.g. by instructing one of the entities or the combined set of entities in FIG. 2, to start executing the trading system in real time. Further, if the input to a trade related action, such as buy or sell actions, are true, that action would initiate real financial transactions, committing real money, as explained earlier.

The live execution functionality is activated by the user selecting the Live tab 342, causing the system to show a test user-interface shown in FIG. 9a. When no previous trading system has been setup for live execution, an empty setup screen as shown in FIG. 9a appears, including an icon/button 958 for initiating the setup of a trading system instance for live execution.

Generally, a trading system instance may be regarded as the combination of a trading system and a specific set of settings with which the trading system is activated, such as which instrument to trade, which chart period to monitor, etc. A process for defining a trading system including a set of rules for which actions should be triggered has been described in connection with FIGS. 4 and 5. These rules may be applied irrespective of whether the system is trading EURUSD on a 5 minute chart, USDDKK on a daily chart, or a stock on an hourly chart. In other words, the system can be reused, by starting the same system with different settings. In the following each combination of a trading system and the setting of said trading system is called an instance.

When the user activates button 958, the system invokes a dialogue box 959 as shown in FIG. 9b. The dialog box 959 provides input control elements for selecting the trading system, and entering initial values for relevant trading system parameters. Examples of such parameters may include the name of the trading system to execute, the financial instrument which the trading system should monitor, and for which trades should be placed, the unit size for the sell and buy actions, the chart time scale that should be monitored, the initial value of any additional trading system parameters, as well as any settings for limiting maximum exposure that can be created by the system.

Upon acknowledgement of the entered parameters, the dialog box disappears and the trading system will now start monitoring relevant financial information in real time and potentially initiate real financial transactions. The display will update to that of FIG. 9c. At the top a row 960 is displayed indicating that an instance of the trading system named “SMA Simple” has been started. It is monitoring the EURUSD financial instrument on a 1 day chart, one unit of investment is 100.000 (EURUSD), and the value of the first additional parameter (shown in the params column 961) is 75.

At the bottom a number of different tabs provide detailed information of the current performance of the trading system instance.

For example the Summary tab 962 shows summary financial information, much like what was presented as the result of a back test. Information includes, profit/loss, rate of return, number of trades, as well as other industry standard metrics used for evaluating the performance of an investment strategy, including “Sharpe Ratio”, “Drawdown”, “Runup” etc.

Another view of the real time performance is shown in FIG. 9d, which is activated by pressing the “Periodical Summary” tab 963. Here the performance of the selected trading system instance is displayed on a periodical basis; period being hourly, daily, weekly, monthly or perhaps yearly.

Yet another view of the real time performance is shown in FIG. 9e. Here an equity curve is plotted. The equity curve shows the development of the invested equity over time, from the start of the live execution, up till current time. It is obvious that many other graphical representations are possible, and are already described in the referenced prior art.

Another view of real time performance is shown in FIG. 9f. This shows a list of all of the trades generated by the selected trading system instance, along with key information, such as the pr trade profit, the number of days the trade was in the market etc.

Yet another view again shown in FIG. 9g, here named “Strategy log”. This view gives a more technical look at what the trading system instance has actually been doing. Entries are made automatically in the log, when the system is started, stopped, when certain actions are triggered, as well as when the system decides to initiate financial transactions.

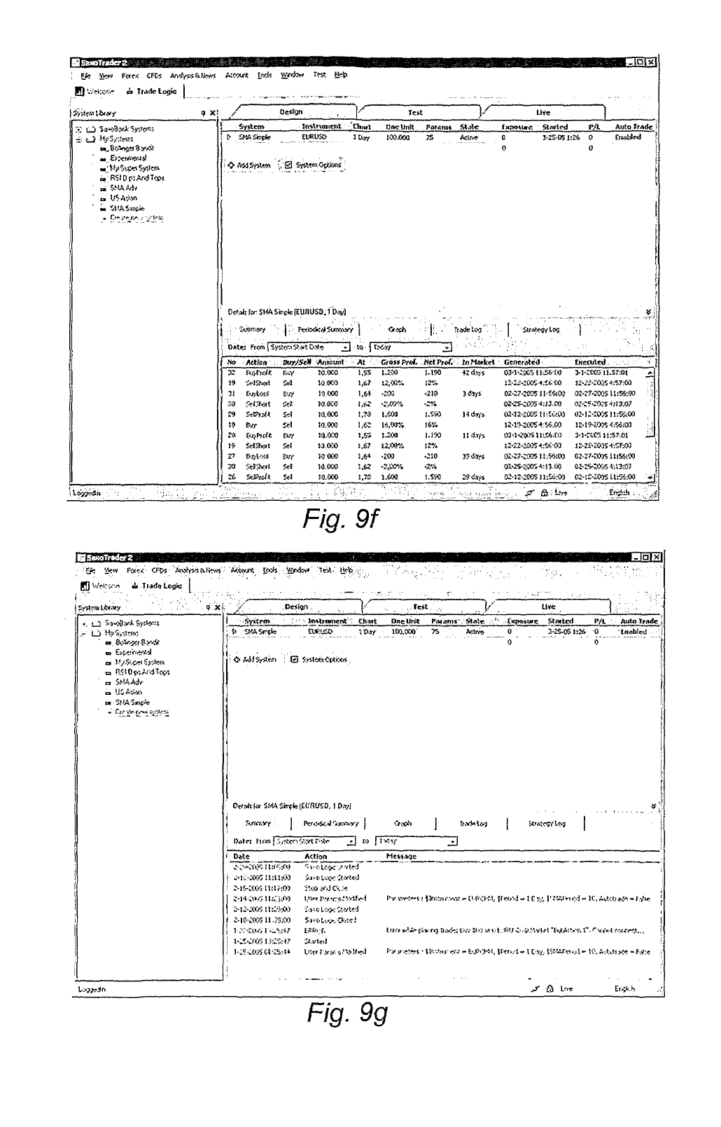

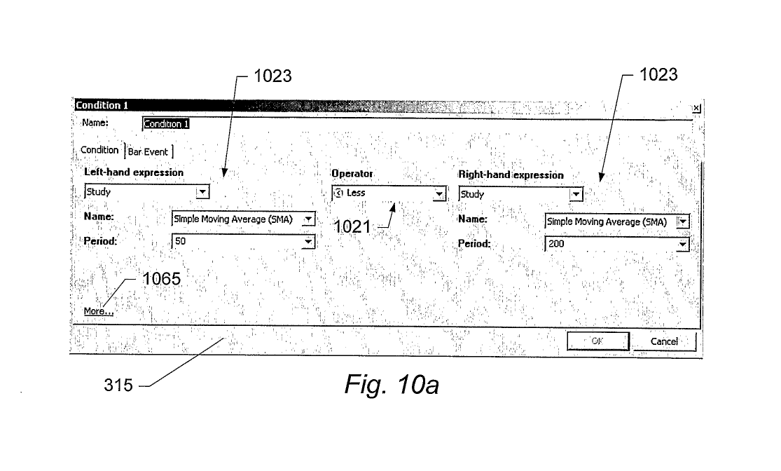

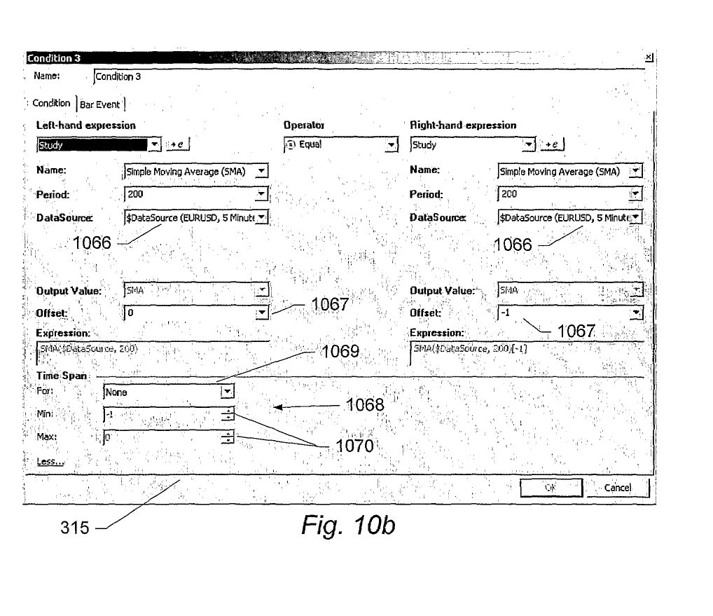

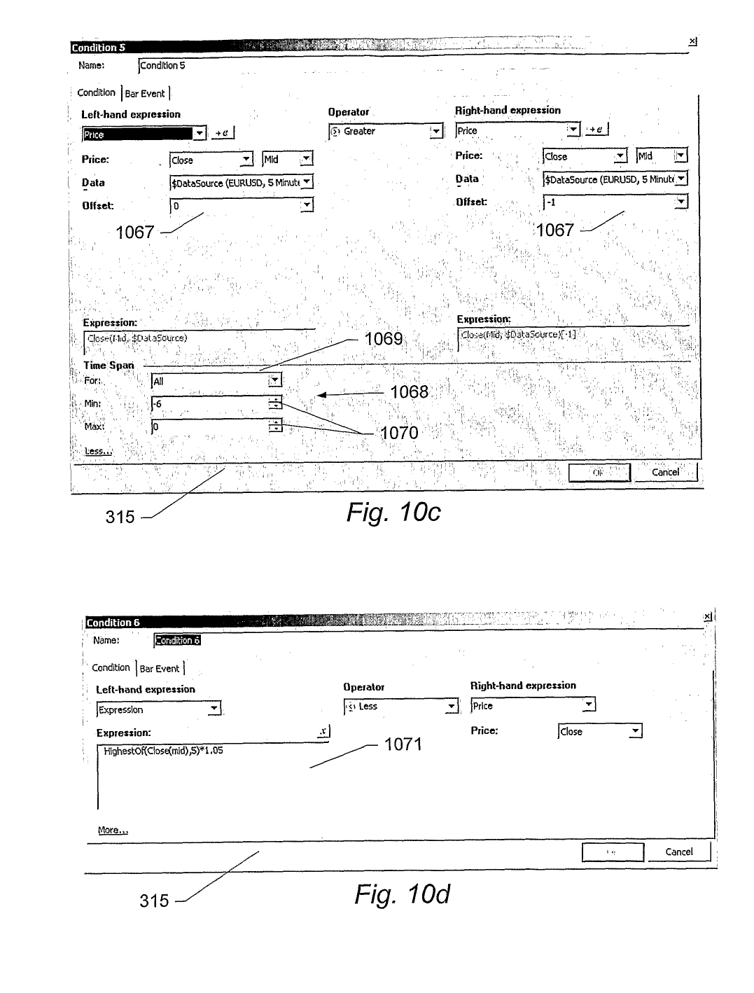

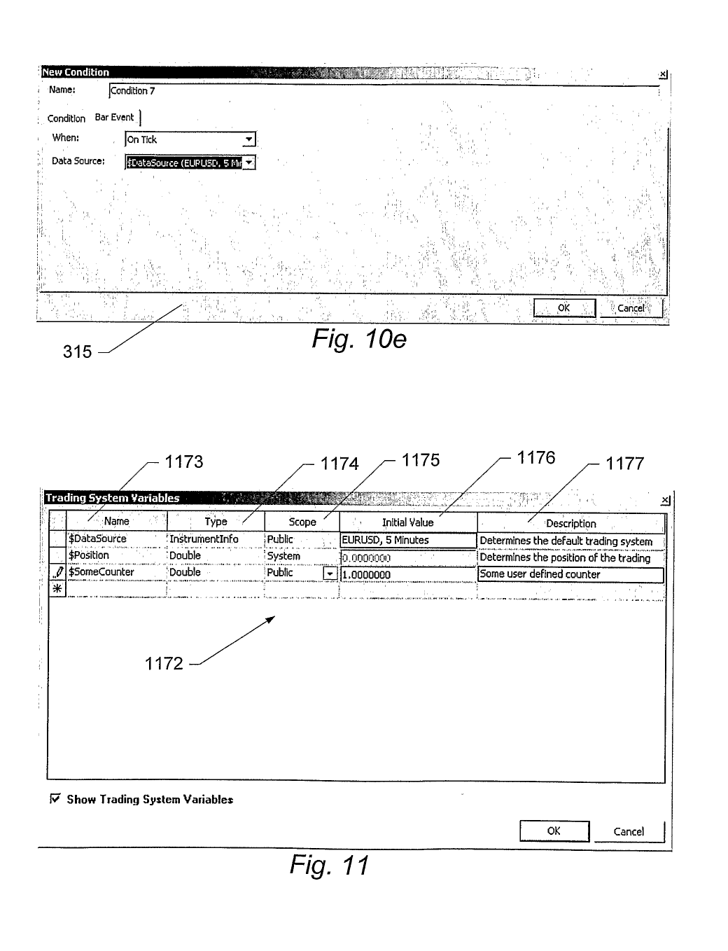

In the following another embodiment of the trading system design surface will be described with reference to FIG. 10. In particular, in this embodiment the complexity of the design process is further reduced while further enhancing the functionality provided in the dialog for defining condition blocks.

FIG. 10a illustrates another embodiment of a dialog box 315 for defining a condition block. In this example of a dialog box, two levels of complexity are introduced for the dialog used to define conditions. Initially this dialog only allows the user to make fairly simple selections, including the selection of the type of expressions 1023 and the comparison operator 1021. The dropdown menus 1023 allow a user to select between different types of expressions, such as ‘simple values’, a property related to a financial instrument, a financial study, the state of the trading system or any combination of the above. As described earlier, the layout and composition of entry fields located adjacent to the first drop down, selecting the type of expression, may vary depending on the type of expression selected. The dialog box further includes a control element 1065 labelled “more.” for invoking an extended version of the dialog box which allows a user to view and set additional options.

FIG. 10b shows an example of the extended version of the dialog box 315. In the extended version of the dialog additional parameters may be set, e.g.:

A DataSource pulldown menu 1066 allows the user to select which financial instrument to use as an input. For example, the user may set up a strategy which buys gold, when the dollar is falling, thus testing on one instrument (data source), but acting on another instrument (data source).

An Offset pull down menu 1067: The properties of a financial instrument over time are often represented in the form of a financial chart. Charts may be created using different time scales. For example a 5 minute chart will show the values of selected properties of a given financial instrument as it changes over time, each 5 minutes. Each segment of time (depending on the selected timescale) is typically referred to as ‘a bar’.

By specifying a value for ‘offset’ the user can specify if the expression that is evaluated on the basis of the most recent ‘bar’ (offset=0), or any previous bar. The latter is indicated by setting the offset to a negative value.

The timespan section 1068 allows a user to specify if the whole condition should be true for more than one bar. The ‘For’ drop down list 1069 allows the user to specify if the condition should hold for all or any of the bars specified within the range given by the ‘Min’ and ‘Max” entry fields 1070. The ‘Min’ and ‘Max’ entry fields allow the user to specify the range of bars for which the condition must hold true.

FIG. 10c shows another example of the extended version of the dialog box 315. In this example the condition dialog box 315 is set up according to the condition Close<Close[−1] for ALL bars between −6 and 0. This amounts to a condition which specifies that the close price for the instrument specified in the data source must have been rising for the last 6 bars.

FIG. 10d shows yet another example of a dialog box that allows a user to specify an expression using mathematical expressions. In the example of FIG. 10d the left expression is entered in a form of programming script in en entry field 1071. In the example of FIG. 10d, the expression states that the current Close Price must be greater than the 1.05 times the highest of any of the previous 5 close prices.

FIG. 10e shows yet another example of a dialog box for defining a condition. This example of a condition is referred to as a Bar Events. A ‘Bar Event’ is a special type of event which becomes true at the moment some specified change occurs in the properties of the financial instrument. When the trading system is based on financial information in the representation of a chart, examples of event types include ‘on tick’, which will be true each time a new price is received, ‘on open’, at the open of every bar on the specified chart, ‘on close’ at the close of every bar on the specified chart or a combination of open and close. Conditions based on bar events makes it easier to control exactly when a particular action should be taken.

In some embodiments, the system provides functionality for defining variables. Such variables may be assigned to in assign blocks, and be used as input to expressions.

FIG. 11 illustrates an example of a user interface for defining variables. The user interface includes a table 1172 for entering variables. There is one row for each variable in the system. The first column 1173 gives the name of the variable, so it can be referred to by that name with in the definition of an expression. The second column 1174 gives the type of the expression, such as ‘double’: a numeric, ‘InstrumentInfo’: information pertaining to a financial instrument, ‘string’: a text string etc. The third column 1175 specifies the scope of the variable. Variables of the ‘system’ scope are updated by the trading system execution software, as the trading system is executing, but can be used as input to expressions. For example the variable, named $position keeps track of whether the trading system is long (position>0) even (position=0) or short (position<0). Variables of the ‘Public Scope’ can be assigned in ‘assign blocks’ and also used as input to expressions.

A further column 1176 labelled “Initial Value” allows the user to define an initial value of the variable, and a description column 1177 includes a textual description of the variable.

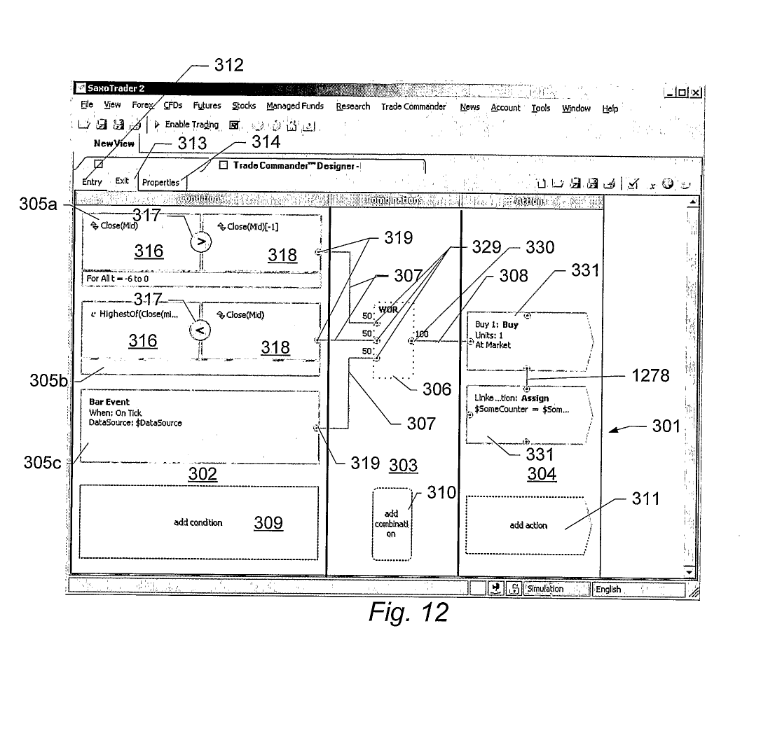

FIG. 12 shows another example of a user-interface of a computer implemented tool for defining a financial trading system. The user interface is similar to the user interface shown in FIG. 4. In this example, the condition pane 302 includes condition blocks 305a-c, where condition block 305a is an example of a condition block including a timespan as set up by the dialog box shown in FIGS. 10b and c; condition block 305b is an example of a condition block representing a mathematical expression as set up by the dialog box shown in FIG. 10d; condition block 305c is an example of a condition block representing a bar event as set up by the dialog box shown in FIG. 10e.

Furthermore, the action pane 304 includes two action blocks 331 connected by line 1278 so as to define a chain or sequence of actions.

In some embodiments the system provides functionality for conducting a series of back tests, while automatically changing the value of one or several variables between each back test. By doing this the user can get an indication of which value of said variables would have provided the optimal result given the selected source of financial information.

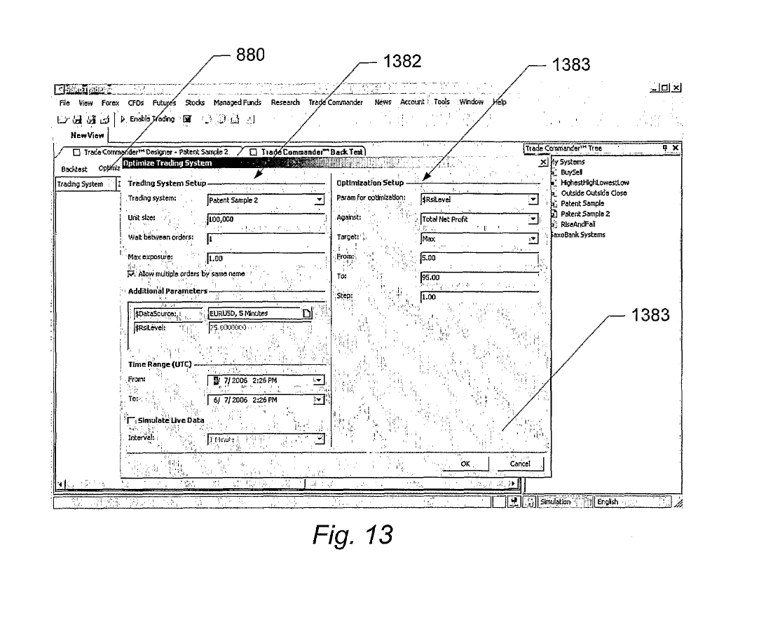

An example of an optimization user interface 1381 is shown in FIG. 13. For example, the user interface of FIG. 13 may be invoked by selecting a corresponding menu item of tab, e.g. tab 880 in FIG. 8a.

The dialog box 1381 includes a left pane 1382 allowing a user to specify the same parameters as those that would be specified when carrying out a regular back test.

At the right side 1383, the dialog includes a pane allowing the user to specify a number of additional parameters:
Which of the variables that should be changed during each back test.
Which of a set of possible performance metrics the trading system should be optimized against.
How the variable to be optimized should be changed between each back test: What should be the start value of the variable, what should be the end variable and what should be the change in this variable between each backtest.

It should be noted that the example of FIG. 13 shows a simple example of optimization. However, it will be appreciated that any commonly known optimization algorithm, including heuristic methods, genetic algorithms etc. may be employed. Further simultaneous optimization of several variables may be implemented at the same time.

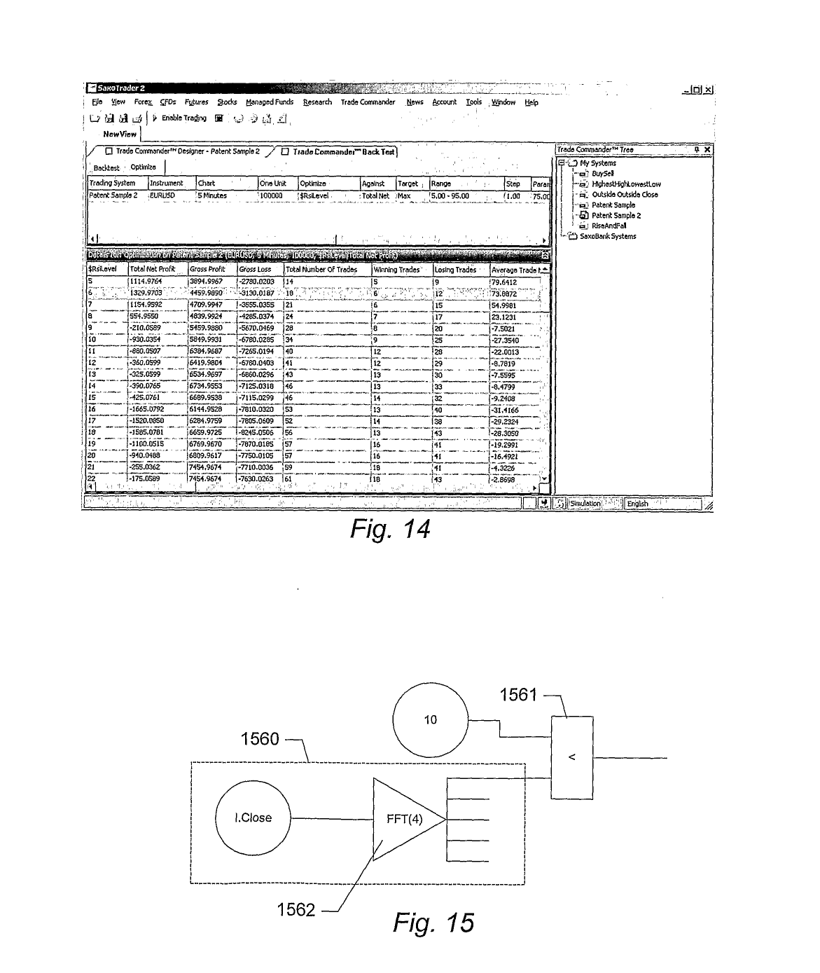

Once the optimization procedure has completed, the result is presented to the user. In one embodiment the result is simply a list of all back test results, with the best result highlighted as shown in FIG. 14.

Hence, in the above, embodiments of a computer-implemented system has been disclosed for defining a trading system. Some of the interesting features of the above system include:
The system enforces strict and useful rules about where to place the components on the screen, in this example conditions to the left, combinations in the middle, actions to the right.
Furthermore, the “condition block” described above is a combination of two filter functions (one for the left-hand expression and one for the right-hand expression) and a comparison function, thereby facilitating the setting up of conditions even for an untrained user.
The above indication of block values during the debugging stage.
The above indication of block values and status during the live execution stage.

In some embodiments, the strict rules enforced by the above embodiment of a software system for defining a trading system, are combined with features that allow advanced users to define additional functions.

For example, another embodiment of a software system for defining a trading system may include a block diagram editor and compiler/interpreter for defining and compiling/interpreting custom studies or filters that afterwards can be used/executed in the condition blocks described above.

In one embodiment of the block diagram editor, the restrictions regarding the placement of building blocks are relaxed and a larger number of different building blocks are provided. Nevertheless, this embodiment also utilises the approach of defining trading systems as a configuration of building blocks. It is an advantage of the system described herein, that it allows a user to more easily define very advanced types of trading systems. In particular, in the present embodiment, the arsenal of available building block types is extended with the following types of building blocks:
Signal generators: One may represent any instrument property or derived property as a signal, since instrument properties vary over time.
Filters for transforming the input from several signal sources into new output(s). An example of a simple filter is a low pass filter. A more advanced example could be a Fast Fourier Transform (FFT) filter which can segregate an incoming signal into several outputs each representing the energy of the signal within a certain frequency band.

In one embodiment, properties of a financial instrument are represented as signals, and filters are defined that act on the instrument properties. Hence, custom components of a trading system are defined by placing graphical elements on a user interface pane, each element representing a signal or a filter. An exemplary user interface allows a user to select graphical elements from a list of elements, represented graphically in a palette of elements. Using an input device of a user system (e.g., mouse, keyboard, trackball, etc.) the user can select elements, optionally set properties of elements, and assemble the elements in an area of the user interface. By means of the input device, the user may further connect the arranged elements with lines that represent the signal/data flow. Using the above,

Some examples of the possible features of tools for defining more complex systems include the following:

It is easy to group several blocks into a new, aggregate block, which can then be reused in other systems. The user can graphically define completely new filtering functionality, for example by filtering back parts of the output of a filter back to its input. The user can comparably easily use filter functions which output several values.

Furthermore, the user may define the function of a filter in a multitude of ways, including:
1. By selecting from a list of filter types, and setting appropriate filter parameters.
2. By simply writing a mathematical expression, using a suitable editor, e.g. a text editor.
3. By graphically drawing the desired filter function on a drawing surface/pane/drawing program.

Generally, in connection with the definition of filters for a financial trading system, the definition of a filter by means of drawing the filter function may be embodied in different ways. For example, the user may draw the desired filter function on an x/y graph with y being the desired amplification and y being the frequency of the input. Alternatively or additionally, the user can graphically draw a pattern, which this filter should match. If for example, the user wants a filter to detect the presence of a ‘head and shoulders pattern’, the user would simply draw the contours of such a pattern. In this case the y axis would be the amplitude (price) and the x axis would be time.

FIG. 15 shows an example of applying FFT for determining when a market is volatile. In this example the output from the comparison block 1561 will be true, if the output from the highest frequency band from the FFT 1562 is greater than 10. Hence, in one embodiment, the user may define a study by means of a block diagram, e.g. the block diagram indicated by the dashed box 1560 in FIG. 15. The system may interpret/compile and store the defined study, thus allowing the user to enter the study as an element in a condition block described herein. Hence, the present embodiment provides a versatile tool for defining even very complicated trading systems in a user-friendly fashion.

Hence, a tool for defining, testing, and executing an automated trading system has been disclosed. The tool is based on a graphical building block principle that allows system elements to be simply added, combined and set up. The building block architecture offers a flexible and powerful system which is at the same time easy to use, and brings complex trading models within the reach of novice, private investors and offers the power and complexity demanded by professional and institutional investors.

In some embodiments, the building blocks of the system include:
Signal Tests: Signal tests typically compare two signals or a signal and a static value and result in a binary output that can be treated logically. Signal tests can also include back tests for a number of periods to see if a particular condition has been true for a number of periods and other more complex time sampling arrangements.
Logical Combinations: The logical outputs of the signal tests can be combined in many ways (for example logical and weighted combinations) and used to trigger an alert or a trade.
Actions: When predefined conditions have been met, action blocks trigger an alert or an actual trade. Actions can be taken based on current account, margin and position status and can also be set up to make iterative trades that increase/decrease a position while defined market conditions prevail.

Use of graphical user interface (GUI): The building block GUI is built around a framework that guides the user through plugging the correct elements into the correct location and to connect the building blocks correctly. The building block GUI system may be complemented by a full scriptable definition language that can be defined as part of existing building blocks or used to build the system independent of the GUI.

The system may be complemented by a framework allowing thorough debugging and back-testing of the system.

In some embodiments, the tool for defining and subsequently executing a trading system may be executed on a client computer that communicates with one or more host/server systems via a suitable communications network, e.g. the Internet. The client computer receives data about one or more financial instruments, which data is fed into the tool during execution of the trading system. The outputs generated by the trading system may be communicated to other software modules executed on the client computer, e.g. modules for generating user alerts, modules for sending trade requests to a host system, and/or the like.

In other embodiments, parts or all of the functionality described above may be supported by software running on servers as described in connection with FIG. 2. In particular the whole process can be controlled remotely by the user via a web or mobile browser, but all software including the software producing the graphical user interface, the software managing and executing trading systems, and the software sending trade requests, monitoring price movements etc. submitting trade requests to external brokers and or exchanges may be hosted at a central location or distributed over a set of cooperating servers.

The system disclosed herein may be executed in combination with one or more other software applications executed in the client computer as to provide a user with a tool for market information and trading, e.g. for forex trading, CFD trading, stock trading, Futures Trading, Option Trading, Commodities Trading, Open Orders, Charts, Quotes, Analysis, News, Summaries, Chat and Company Information.

Although some embodiments have been described and shown in detail, the invention is not restricted to them, but may also be embodied in other ways within the scope of the subject matter defined in the following claims.

In particular, the user-interfaces described herein have been described to include specific control elements, such as command buttons, tabs, check-boxes, text boxes, option buttons, list boxes, combo boxes, toggle buttons, spin buttons, scroll bars, pull-down menus, etc. It will be appreciated that other embodiments may include alternative or additional control elements for activating a predetermined function, selecting one or more of a number of options, entering data, and/or the like.

Embodiments of the method described herein can be implemented by means of hardware comprising several distinct elements, and by means of a suitably programmed microprocessor. In the device claims enumerating several means, several of these means can be embodied by one and the same item of hardware, e.g. a suitably programmed microprocessor, one or more digital signal processor, or the like. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, integers, steps or components but does not preclude the presence or addition of one or more other features, integers, steps, components or groups thereof.

1. A computer-implemented system for facilitating definition of a computer-executable financial trading strategy, the system being adapted to provide a graphical user interface for defining a financial trading strategy by arranging interconnectable building blocks into a diagram on a drawing pane provided by the graphical user interface, each building block representing a functional system component of the financial trading strategy; wherein the system includes a plurality of types of functional system components, wherein the drawing pane includes a corresponding plurality of sub-panes, each sub-pane being adapted to receive building blocks of a corresponding one of the types of building blocks; and wherein the system is configured to provide functionality for a user-controlled placement of a building block of a first type within a first sub-pane corresponding to the first type of building blocks.

2. A system according to claim 1, wherein each building block is indicative of a predetermined computer-executable function configured to cause, when executed on a computer, the computer to receive a predetermined input signal, to process the receiving input signal according to a corresponding rule, and to generate an output resulting from said processing.

3. A system according to claim 1, wherein the types of building blocks include condition blocks, wherein each of at least one type of condition blocks is indicative of a predetermined computer-executable condition function configured to cause, when executed on a computer, the computer to receive two predetermined input signals, to perform a predetermined comparison operation on the input signals and to output an output signal indicative of a binary result of the comparison operation.

4. A system according to claim 3, wherein each of the first and second input signals is indicative of at least one of a time series of an instrument property, a study of a financial instrument, and a current or past state of the trading system.

5. A system according to claim 3, wherein the first and second input signals are user-selectable ones of a predetermined set of instrument properties and/or instrument studies; and wherein the comparison operation is a user-selectable one of a number of comparison operations.

6. A system according to claim 3, wherein the predetermined computer-executable condition function is further configured to cause, when executed on a computer, the computer to process at least one of the received input signals, and to perform the comparison operation of the processed input signals.

7. A system according to claim 1, wherein the types of building blocks include combination blocks, wherein each combination block is indicative of a predetermined computer-executable logic function configured to cause, when executed on a computer, the computer to receive at least two predetermined input signals, each indicative of a corresponding binary value, and to perform a predetermined logic function on the input signals and to output an output signal indicative of a binary result of the logic function.

8. A system according to claim 1, wherein the types of building blocks include action blocks, wherein each action block is indicative of a predetermined computer-executable function configured to cause, when executed on a computer, the computer to receive a predetermined input signal indicative of a binary value, and to perform a predetermined computer-executable action responsive to the input signal.

9. A system according to claim 8, wherein the action includes one of initiating an automated trade transaction and triggering an alert for alerting a user.

10. A system according to claim 1, wherein the types of building blocks include condition blocks, combination blocks and action blocks.

11. A system according to claim 10, wherein the drawing pane includes three sub-panes each for a respective type of building blocks; and wherein a first sub-pane configured to receive condition blocks has a common first border line with a second sub-pane configured to receive combination blocks; and wherein the second sub-pane has a common second border line with a third sub-pane configured to receive action blocks.

12. A system according to claim 10, wherein each combination block is configurable to receive respective output signals from at least two condition blocks as inputs to the combination block; and wherein each action block is configurable to receive an output signal of a combination block as the input signal to the action block.

13. A system according to claim 1, wherein the financial instrument is one of a currency, a contract for difference, a stock, a future, an option, and a commodity.

14. A system according to claim 1, further adapted to execute a defined computer-implemented trading strategy in a test mode for testing the computer-executable financial trading strategy.

15. A system according to claim 1, wherein each of at least a subset of building blocks includes an indicator configured to indicate a binary value of an output signal of the building block during execution of the financial trading system in at least one of a test/debugging mode and a live execution mode.

16. A system according to claim 1, wherein each of at the comparison blocks include numeric or text indicators configured to indicate a numeric or textual value of the expressions at each side of the comparison building block during execution of the financial trading system.

17. A system according to claim 1, wherein each sub-pane includes a user-operable control element configured to initiate insertion of a building block of a type corresponding to said sub-pane in said sub-pane.

18. A system according to claim 1, wherein the computer-executable trading strategy includes an exit strategy and an entry strategy, and wherein the user-interface includes at least a first drawing pane for defining the entry strategy and a second drawing pane for defining the exit strategy.

19. A system according to claim 1, further adapted to translate the diagram of interconnected building blocks into computer-implemented instructions for executing the financial trading strategy.

20. A system according to claim 1, further adapted to execute computer-implemented instructions responsive to the diagram.

21. A computer-implemented method of generating a computer-executable financial trading strategy, the method comprising—arranging interconnectable building blocks into a diagram on a drawing pane provided by a graphical user interface for defining a financial trading strategy, each building block representing a functional system component of the financial trading strategy; wherein arranging comprises placing building blocks of different types in respective sub-panes, each for receiving a corresponding type of building block; —interconnecting the building blocks by lines indicative of a signal flow between interconnected building blocks; —translating the diagram of interconnected building blocks into computer-implemented instructions for executing the financial trading strategy.

22. A method according to claim 21, wherein each building block is indicative of a predetermined computer-executable function configured to cause, when executed on a computer, the computer to receive a predetermined input signal, to process the receiving input signal according to a corresponding rule, and to generate an output resulting from said processing.

23. A method according to claim 21, wherein the types of building blocks include condition blocks, wherein each condition block is indicative of a predetermined computer-executable condition function configured to cause, when executed on a computer, the computer to receive two predetermined input signals, to perform a predetermined comparison operation on the input signals and to output an output signal indicative of a binary result of the comparison operation.

24. A method according to claim 23, wherein each of the first and second input signals is indicative of at least one of a time series of an instrument property, a study of a financial instrument, and a current or past state of the trading system.

25. A method according to claim 23, further comprising—selecting each of the first and second input signals responsive to a user-input to be a corresponding instrument property or study from a predetermined set of instrument properties and/or instrument studies; and—selecting the comparison operation responsive to a user-input to be one of a number of comparison operations.

26. A method according to claim 23, wherein the predetermined computer-executable condition function is further configured to cause, when executed on a computer, the computer to process at least one of the received input signals, and to perform the comparison operation of the processed input signals.

27. A method according to claim 21, wherein the types of building blocks include combination blocks, wherein each combination block is indicative of a predetermined computer-executable logic function configured to cause, when executed on a computer, the computer to receive at least two predetermined input signals, each indicative of a corresponding binary value, and to perform a predetermined logic function on the input signals and to output an output signal indicative of a binary result of the logic function.

28. A method according to claim 21, wherein the types of building blocks include action blocks, wherein each action block is indicative of a predetermined computer-executable function configured to cause, when executed on a computer, the computer to receive a predetermined input signal indicative of a binary value, and to perform a predetermined computer-executable action responsive to the input signal.

29. A method according to claim 28, wherein the action includes one of initiating an automated trade transaction and triggering an alert for alerting a user.

30. A method according to claim 21, wherein the types of building blocks include condition blocks, combination blocks and action blocks.

31. A method according to claim 30, wherein the drawing pane includes three sub-panes each for a respective type of building blocks; and wherein a first sub-pane configured to receive condition blocks has a common first border line with a second sub-pane configured to receive combination blocks; and wherein the second sub-pane has a common second border line with a third sub-pane configured to receive action blocks.

32. A method according to claim 30, wherein each combination block is configurable to receive respective output signals from at least two condition blocks as inputs to the combination block; and wherein each action block is configurable to receive an output signal of a combination block as the input signal to the action block.

33. A method according to claim 21, wherein the financial instrument is one of a currency, a contract for difference, a stock, a future, an option, and a commodity.

34. A method according to claim 21, including executing a defined computer-executable financial trading strategy in a test mode for testing the computer-executable financial trading strategy.

35. A method according to claim 21, further including indicating a binary value of an output signal of each of at least a subset of building blocks during execution of the financial trading system in the test mode.

36. A method according to claim 21, wherein each of at the comparison blocks include numeric or text indicators configured to indicate a numeric or textual value of the expressions at each side of the comparison building block during execution of the financial trading system in at least one of a test/debugging mode and a live execution mode.

37. A method according to claim 21, further comprising initiating insertion of a building block of a first type in the corresponding sub-pane responsive to a user-controlled activation of a control element positioned in said sub-pane.

38. A method according to claim 21, wherein the computer-executable trading strategy includes an exit strategy and an entry strategy, and wherein the user-interface includes at least a first drawing pane for defining the entry strategy and a second drawing pane for defining the exit strategy.

39. A method according to claim 21, further comprising executing computer-implemented instructions responsive to the diagram.

40. A computer program product comprising program code means adapted to cause a data processing system to perform the steps of the method according to claim 21, when said program code means are executed on the data processing system.

41. A data processing system configured to perform the steps of the method according to claim 21.
